(19) United States
(12) Patent Application Publication
(10) Pub. No.: US 2013/0211960 A1
(43) Pub. Date: Aug. 15, 2013

(54) ASSET MANAGEMENT SYSTEM AND METHOD

(71) Applicants: Peter Scully, Brentwood, TN (US); Jon Weston, Frisco, TX (US)

(72) Inventors: Peter Scully, Brentwood, TN (US); Jon Weston, Frisco, TX (US)

(21) Appl. No.: 13/543,590

(22) Filed: Jul. 6, 2012

Related U.S. Application Data
(60) Provisional application No. 61/504,854, filed on Jul. 6, 2011.

(51) Int. Cl. G06Q 30/06

(52) U.S. Cl. CPC G06Q 30/0623
USPC 705/26.41

(57) ABSTRACT

A system to manage, review, and process distressed real estate and other assets, including, but not limited to, performing and nonperforming notes, substandard assets, and other real estate owned (OREO) assets. The system may be hosted on one or more servers on a network, such as the Internet, and accessible to financial institutions and other users through a web browser or similar program. Alternatively, the system may be hosted on an institution's own computers. The system may be used by banks, credit unions, savings and loan institutions, asset management companies, financial institutions, real estate development companies, and other holders of assets to list such assets and make them available for review by potential investors or purchasers, and tracks said assets until said assets are sold or “off-loaded.”

This application claims benefit of and priority to U.S. Provisional Application No. 61/504,854, filed Jul. 6, 2011, by Peter Scully and Jon Weston, and is entitled to that filing date for priority. The specification, figures and complete disclosure of U.S. Provisional Application No. 61/504,854 are incorporated herein by specific reference for all purposes.

### FIELD OF INVENTION

This invention relates to a computer-implemented system and method to manage, review, sell and purchase distressed real estate and other assets.

### BACKGROUND OF THE INVENTION

Due to recent financial developments, banks and financial institutions find themselves holding a significant number of assets or properties, many of which are nonperforming or under-performing. Many of these institutions desire to sell or “offload” these assets, but at present, the mechanisms to do so, such as conducting a public or private auction, are not efficient at attracting a large number of potential purchasers or inventors or in maximizing the value of the asset or property for the institution. According, what is needed is a system that enables an institution to manage its assets or properties and present them to potential purchasers or inventors to maximum benefit.

### SUMMARY OF INVENTION

In various exemplary embodiments, the present invention comprises a computer-implemented system and method to manage, review, and process distressed real estate and other assets, including, but not limited to, performing and nonperforming notes, substandard assets, and other real estate owned (OREO) assets. The system may be hosted on one or more servers on a network, such as the Internet, and accessible to financial institutions and other users through a web browser or similar program. Alternatively, the system may be hosted on an institution's own computers. The system may be used by banks, credit unions, savings and loan institutions, asset management companies, financial institutions, real estate development companies, and other holders of assets to list such assets and make them available for review by potential investors or purchasers, and tracks said assets until said assets are sold or “off-loaded.”

### BRIEF DESCRIPTION OF THE DRAWINGS

FIG. 1 shows a system architecture for a system in accordance with an embodiment of the present invention.

FIGS. 2-6 show exemplary data tables for a system in accordance with an embodiment of the present invention.

FIG. 7 shows a view of a login screen for a system in accordance with an embodiment of the present invention.

FIG. 8 shows a view of a home page screen for an internal client administrator for a system in accordance with an embodiment of the present invention.

FIG. 9 shows a view of an account settings page for a system in accordance with an embodiment of the present invention.

FIG. 10 shows a view of a user modification screen for a system in accordance with an embodiment of the present invention.

FIG. 11 shows a reset password function for a system in accordance with an embodiment of the present invention.

FIG. 12 show an administrator notification screen for a system in accordance with an embodiment of the present invention.

FIG. 13 shows an audience selection screen for a system in accordance with an embodiment of the present invention.

FIG. 14 shows a message input screen for a system in accordance with an embodiment of the present invention.

FIG. 15 shows a notification modification screen in accordance with an embodiment of the present invention.

FIG. 16 shows an assets tab home screen in accordance with an embodiment of the present invention.

FIG. 17 shows a document type setup screen in accordance with an embodiment of the present invention.

FIG. 18 shows a list setup screen in accordance with an embodiment of the present invention.

FIG. 19 shows a search result page in accordance with an embodiment of the present invention.

FIG. 20 shows a search results sorting screen in accordance with an embodiment of the present invention.

FIG. 21 shows a property/asset summary view page in accordance with an embodiment of the present invention.

FIG. 22 shows a property/asset documents page in accordance with an embodiment of the present invention.

FIG. 23 shows a property/asset photos page in accordance with an embodiment of the present invention.

FIG. 24 shows a property/asset map page in accordance with an embodiment of the present invention.

FIG. 25 shows a property/asset workout users page in accordance with an embodiment of the present invention.

FIG. 26 shows a property/asset external users page in accordance with an embodiment of the present invention.

FIG. 27 shows an add asset function screen in accordance with an embodiment of the present invention.

FIG. 28 shows an add asset page in accordance with an embodiment of the present invention.

FIG. 29 shows a document listing page in accordance with an embodiment of the present invention.

FIG. 30 shows a document upload screen in accordance with an embodiment of the present invention.

FIG. 31 shows a photo upload screen in accordance with an embodiment of the present invention.

FIG. 32 shows a dashboard tab portfolio overview page in accordance with an embodiment of the present invention.

FIG. 33 shows a third-party notification tab home page in accordance with an embodiment of the present invention.

FIG. 34 shows a third-party search page in accordance with an embodiment of the present invention.

FIG. 35 shows a third-party search results listing in accordance with an embodiment of the present invention.

FIG. 36 shows a third-party property/asset summary page in accordance with an embodiment of the present invention.

FIG. 37 shows a third-party property/asset documents page in accordance with an embodiment of the present invention.

FIG. 38 shows a third-party property/asset photos page in accordance with an embodiment of the present invention.

FIG. 39 shows a third-party property/asset map page in accordance with an embodiment of the present invention.

FIG. 40 shows a third-party interest confirmation window in accordance with an embodiment of the present invention.

FIG. 41 shows a summary table of functions by user type for a system in accordance with an embodiment of the present invention.

### DETAILED DESCRIPTION OF EXEMPLARY EMBODIMENTS

In various exemplary embodiments, the present invention comprises a computer-implemented system and method to manage, review, and process distressed real estate and other assets, including, but not limited to, performing and nonperforming notes, substandard assets, and other real estate owned (OREO) assets. The system may be hosted on one or more servers on a network, such as the Internet, and accessible to financial institutions and other users through a web browser or similar program. Alternatively, the system may be hosted on an institution's own computers. The system may be used by banks, credit unions, savings and loan institutions, asset management companies, financial institutions, real estate development companies, and other holders of assets to list such assets and make them available for review by potential investors or purchasers, and tracks said assets until said assets are sold or “off-loaded.”

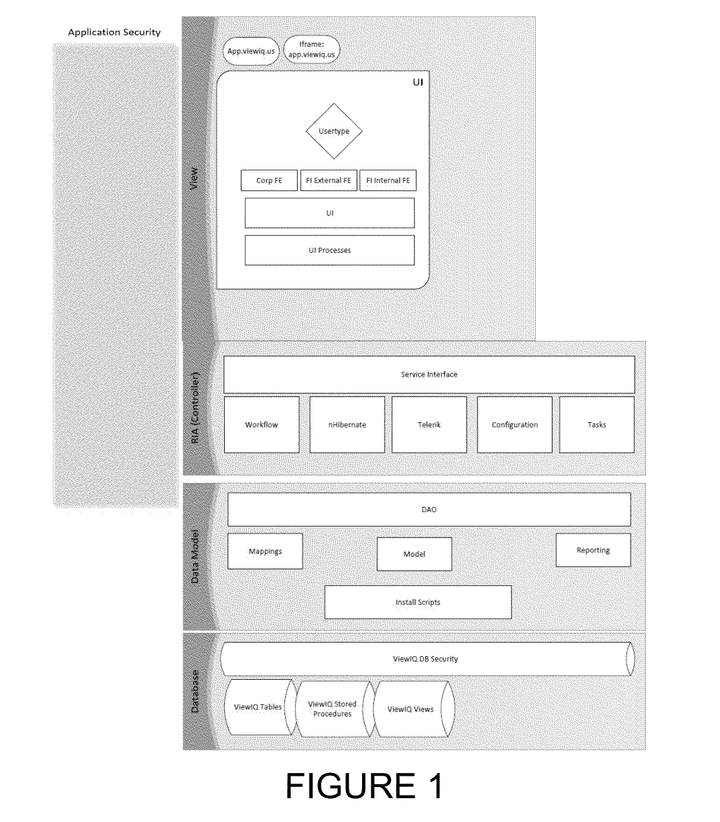

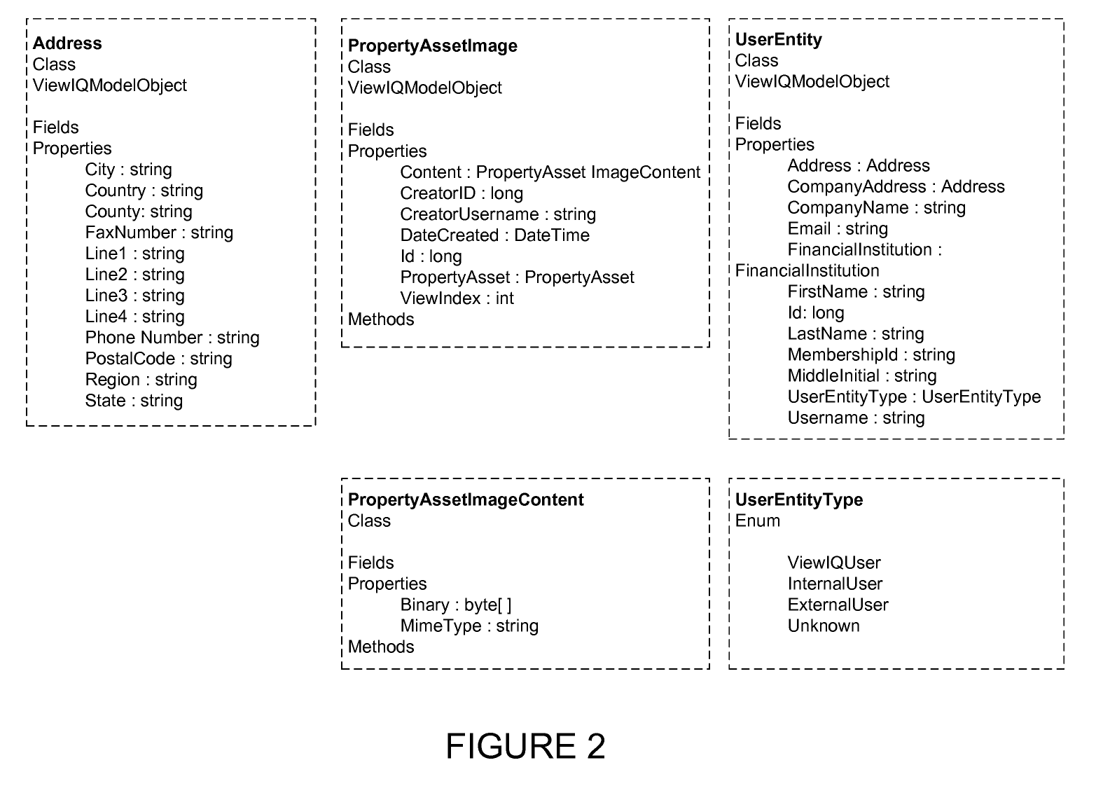

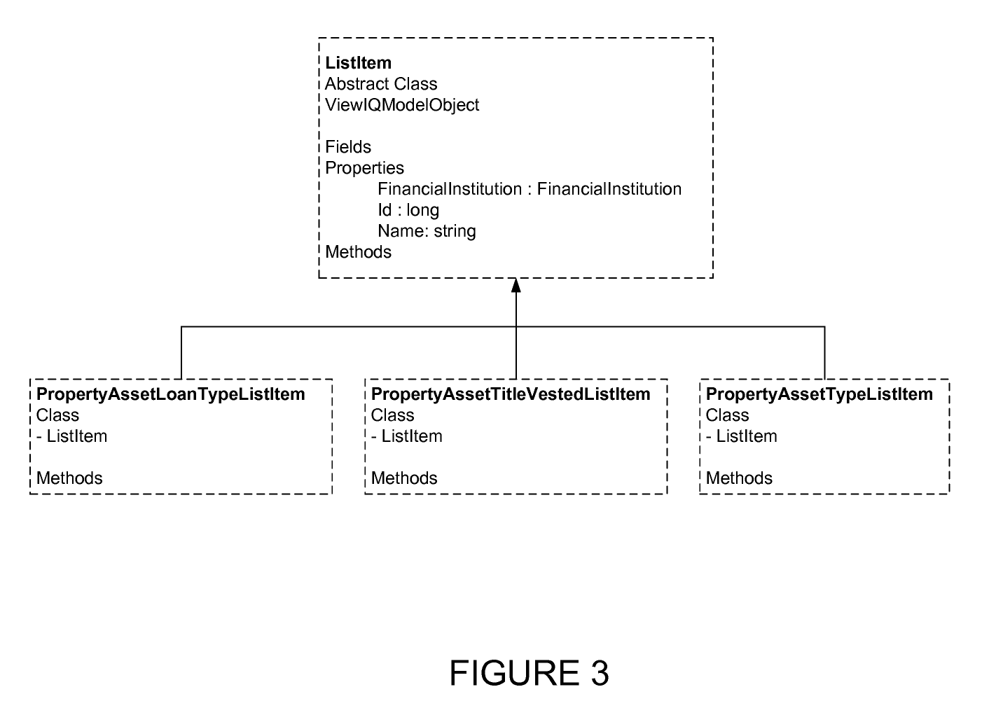

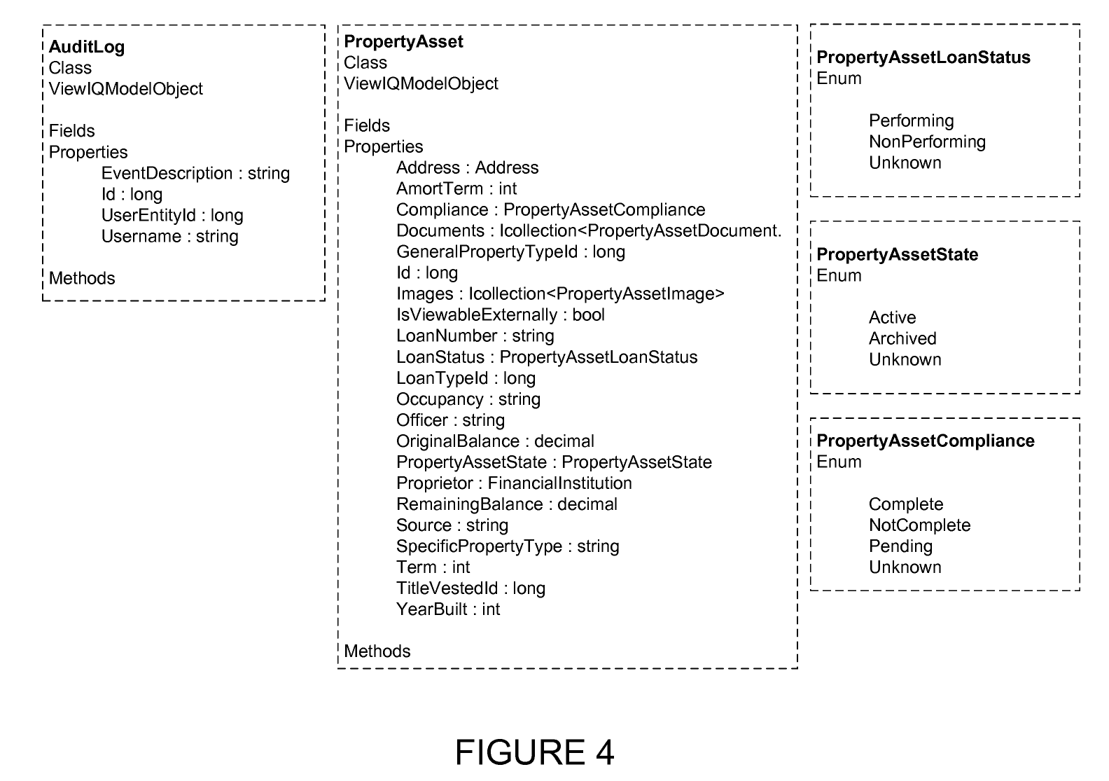

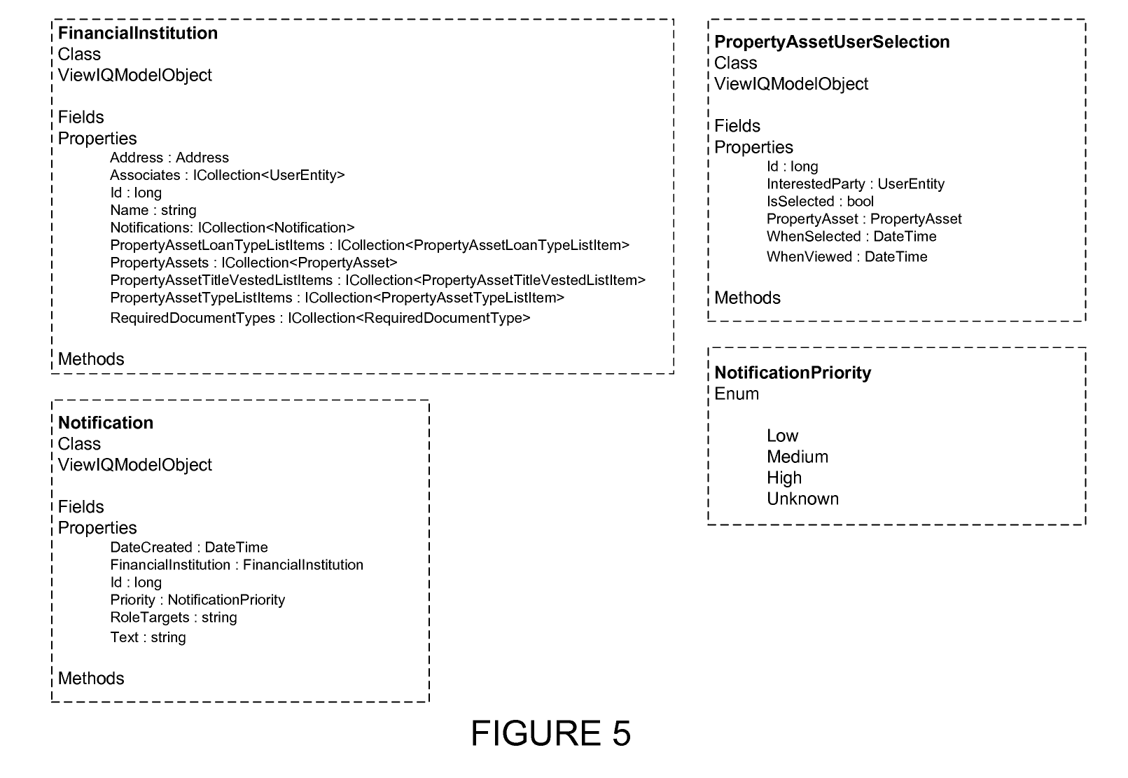

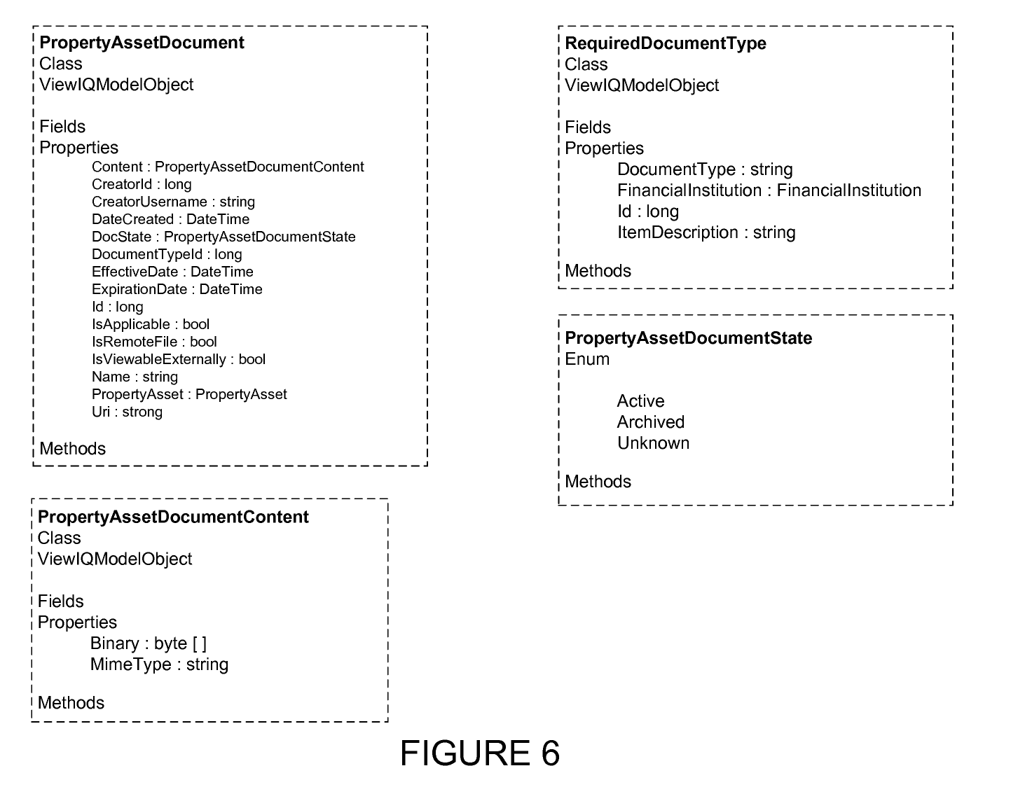

The system comprises one or more databases in electronic communication with the servers or computing devices used for operating the system, as seen in FIG. 1. The database comprises a plurality of data fields relating to the assets and asset holding institution (i.e., “client”). For example, the data fields for the client include, but are not limited to, client name, client address, client home time zone, primary contact name, primary contact email, primary contact telephone, primary contact salutation and suffix, and primary contact job title. Examples of data tables for one embodiment of the present invention are shown in FIGS. 2-6.

The system's database comprises data records about each asset owned or managed by the client and a plurality of asset or property files. The system securely stores asset or property data and associated documents related to the property, such as internal bank or institution information (e.g., loan documents) and external information (e.g., appraisals, MLS listings, broker agreements, construction documents, courthouse records, environmental documents, insurance policies, tax records, photos, SWOT analyses, rent rolls, financial projections, and expenses).

The system maintains the data and documents in real time (or near real time) and dates each data record, which the system tracks for expiration date purposes. The system notifies the client at an appropriate time prior to the expiration data that a particular action is required (e.g., an appraisal is within 60 days of expiration, thereby requiring the client to order a new appraisal). The system provides an automatic, system-generated series of notification alerts for the document or data for which action is required. In one embodiment, alerts are provided in the form of a red circle or other icon adjacent to the document or data.

The client enters or uploads asset data by an authorized user logging into an client administrative account, and using the asset addition or update screen. The user enters or modifies the database fields for the asset. The system can differentiate between commercial and residential properties, and allows multiple images (e.g., photographs) to be stored and displayed for each asset or property. An asset or property will be in one of three states within the system:

Under Review—the entry of data is in progress or incomplete, and the asset or property is not visible to investors/purchasers.

Active—the entry of data is complete, and the asset or property is visible to investors/purchasers.

Archived—the asset or property is no longer visible to investors/purchasers, and no longer displays in searches and reports.

In one exemplary embodiment, the system has at least four types of users. Host Administrators are users with the hosted system itself (which possesses data from a plurality of clients), and have the ability to perform all functions across all client data. This includes, but is not limited to, adding, updating, modifying and deleting asset and property information and associated data, as well as adding, updating, modifying and deleting client and user accounts.

Clients have two types of users. First, Internal Client Administrators have administrative authority for that client's accounts and data. The can perform all system functions, including user administration, but only for the data within that client institution. They also have full visibility and access across all assets and properties within that client institution.

In contrast, Internal Client Read Only users have no user administration privileges, and do not have edit privileges across all properties. They are, in general, limited to only accessing data within the client institution. If this type of user wants to add, delete or update file, they must submit a request to the Internal Client Administrator. In some embodiments, an additional type of internal user account may be present, the Internal Workout user. This type of user is a step up from the Internal Client Read Only user, and has the ability to make changes to and update certain assets and property assigned to them. They can update files, status, notifications, and documents.

The fourth type of user is the Third Party user. Generally, these are potential investors or purchasers of assets or property. They can only see and access properties that are in an active status. They can mark properties or assets of interest to them (so they can be quickly referenced at a later time), and indicate to a client on which properties or assets they would like to bid. These accounts are read only, and have not updating or deletion capabilities.

All users must have an account with the system in order to access and use the system. In general, user account attributes include, but are not limited to, last name, first name, middle name or initial, username, email address, mailing address, phone number, salutation, suffix, and job title. Each account also has a type of account indicator, and secure access information (e.g., password, backup security question). Users associated with a particular client also will have that client indicated in their account data.

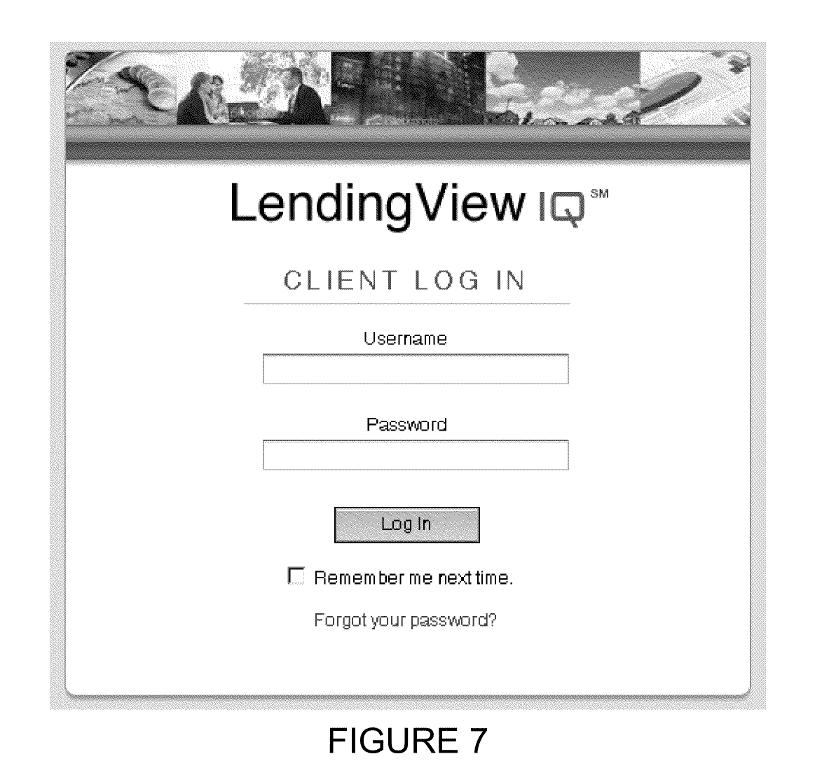

In one embodiment, the user uses an Internet browser on a computing device to access the system at a particular website, and may initially be presented with a login screen. An example of a user login screen is shown on FIG. 7, which prompts the user to enter their username and password for access.

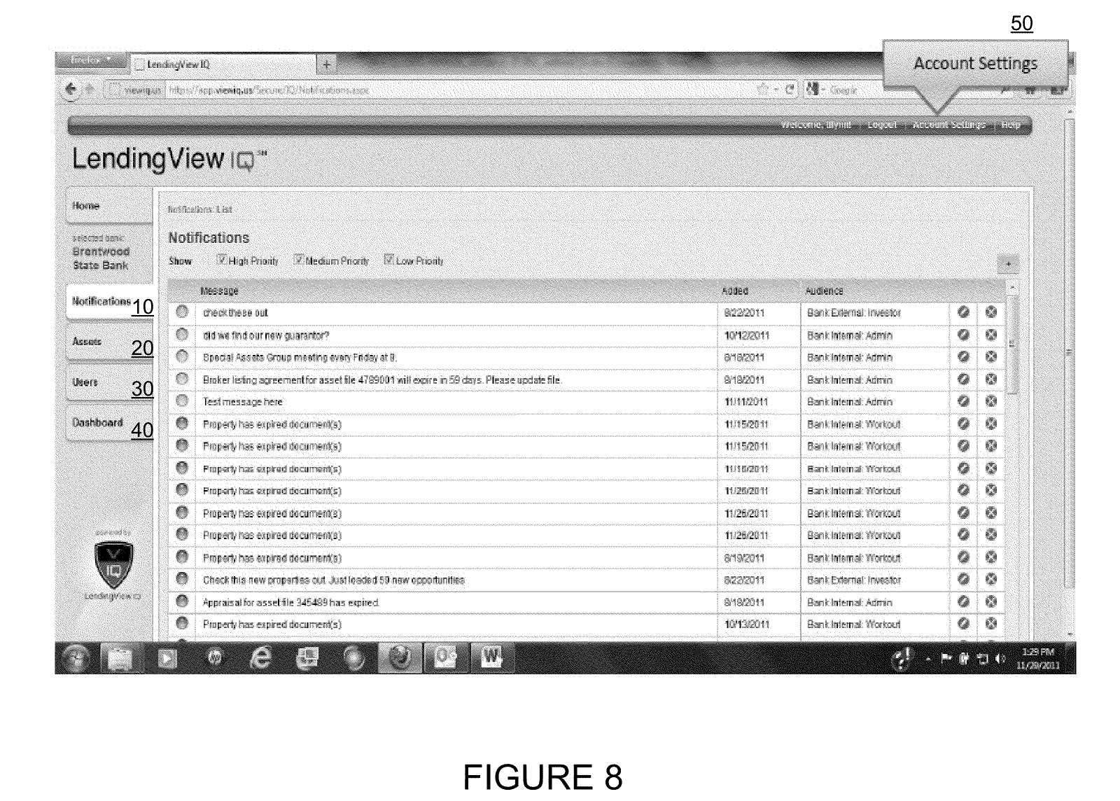

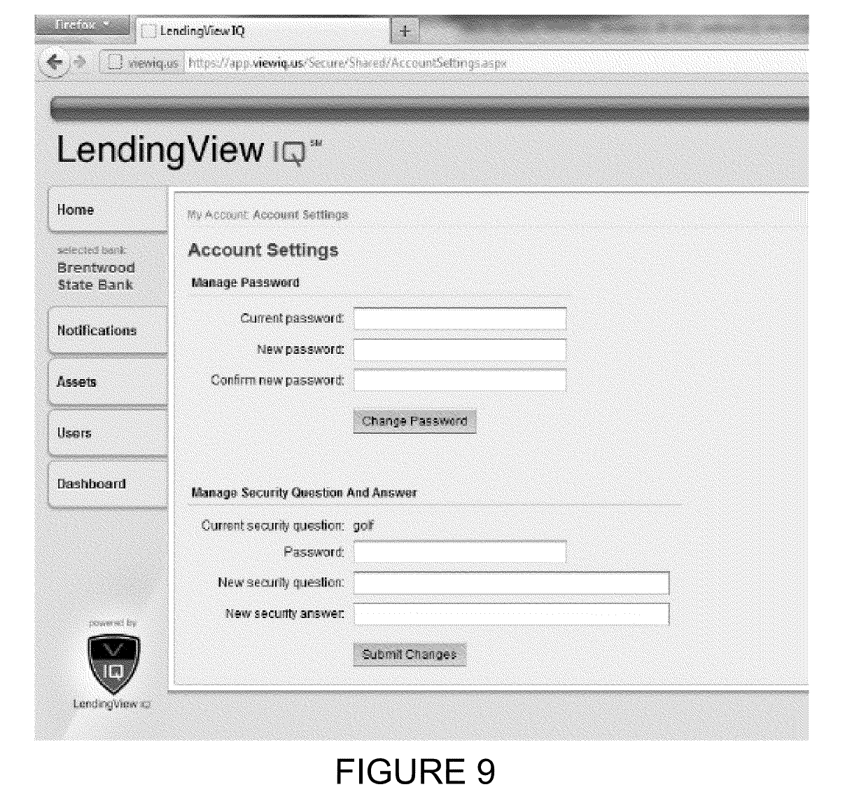

After logging in, the user is directed to a “home page” appropriate for that type of user. A client user, for example, is directed to a home page for that client institution, typically containing the institution's name or logo. An example of a client institution home page for an internal client administrator is shown in FIG. 8. As seen in this embodiment, the client user can access tabs for Notifications 10, Assets 20, Users 30, and Dashboard 40. Users also can manage their own passwords, and change them from time to time, by using the Account Settings function 50. An example of an account settings page is seen in FIG. 9.

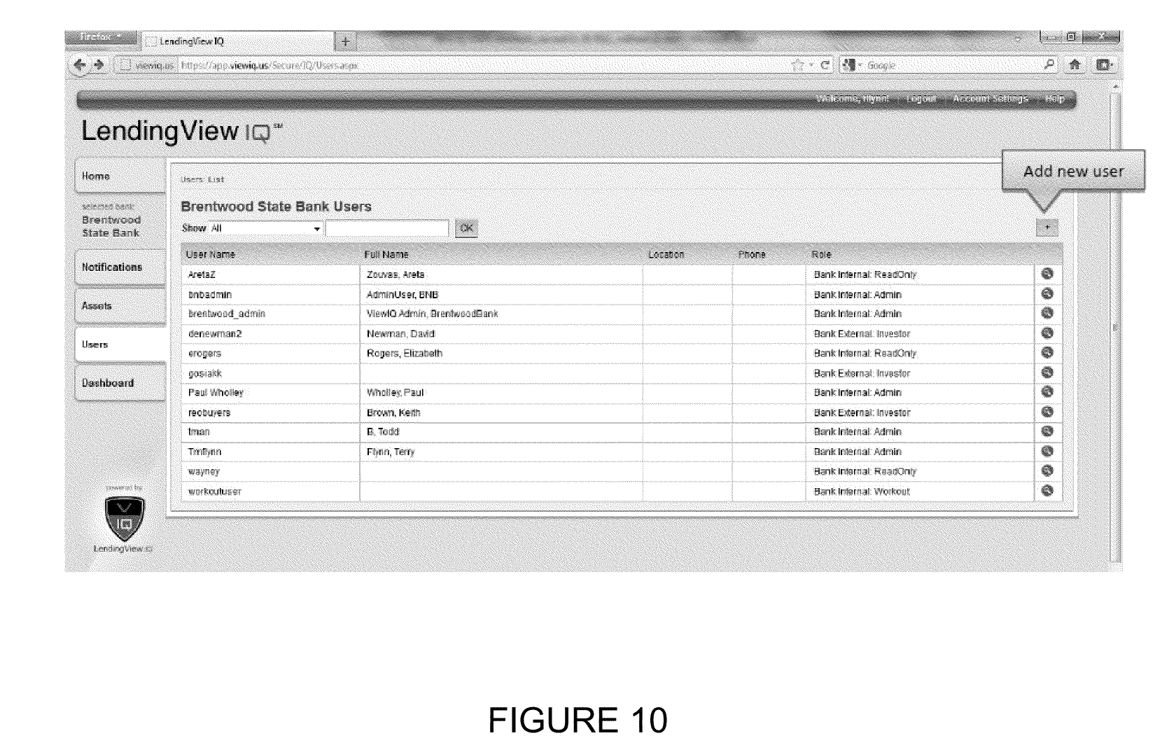

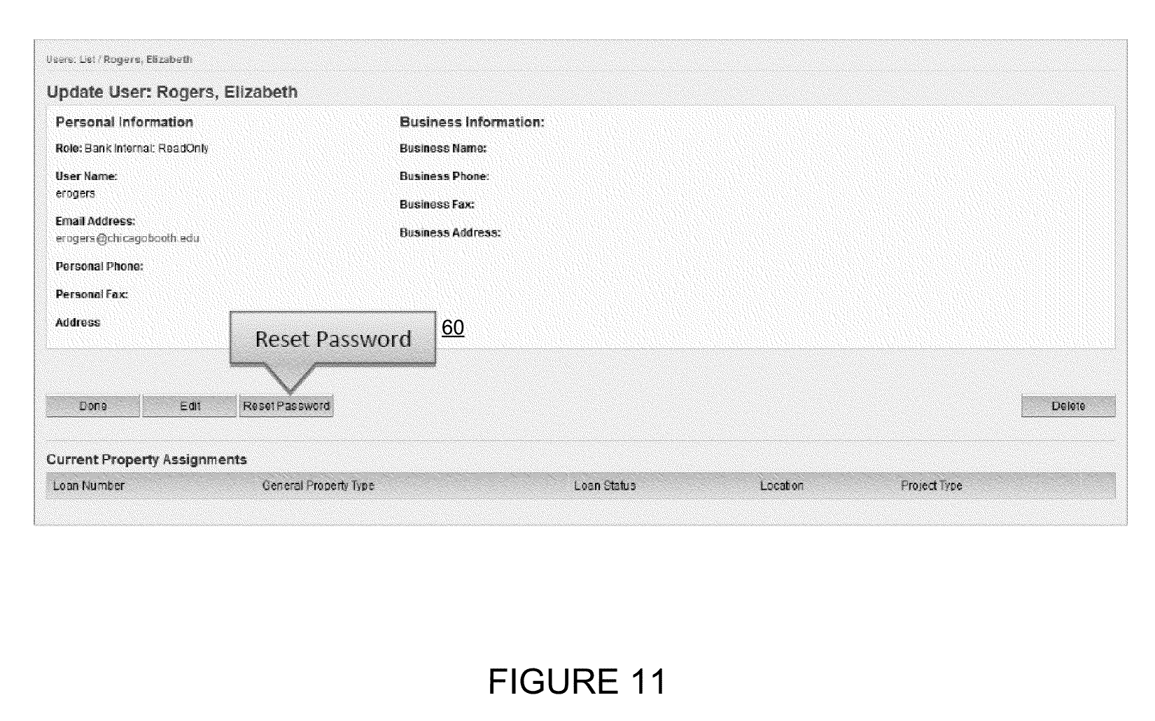

The Users tab provides information about all users. Administrative users can add, modify and delete users in this area (as seen in FIG. 10). Administrative users can reset a user's password by accessing the Users tab 30, and initiating the Reset Password function 60 for the desired user on the list. An example of this is shown in FIG. 11.

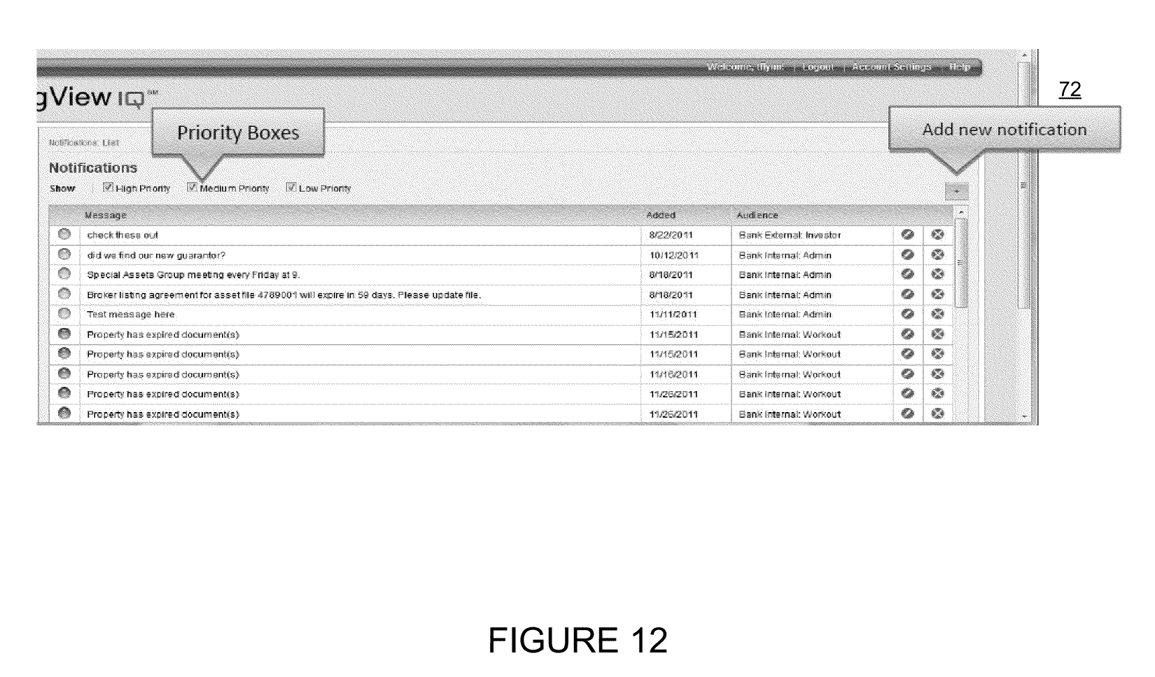

The Notifications tab displays two types of notifications for user. An example of a notification screen for administrators is seen in FIG. 12. System generated alerts are alerts that the system generates based on file information contained in the system, such as an alert to order a new appraisal, a notice to update or renew an insurance policy, or a notice to renew MLS (Multiple Listing Service) for a property. Internal administrative user notifications are generated by an internal administrative user. Examples include, but are not limited to, notice to update a file or requests for additional information from other users, notice of upcoming events (such as training sessions for new users), and reminders to users for various activities (such as due date for investors to submit bids on OREO properties). Notifications are classified by user type, and not all notifications will be seen by all users.

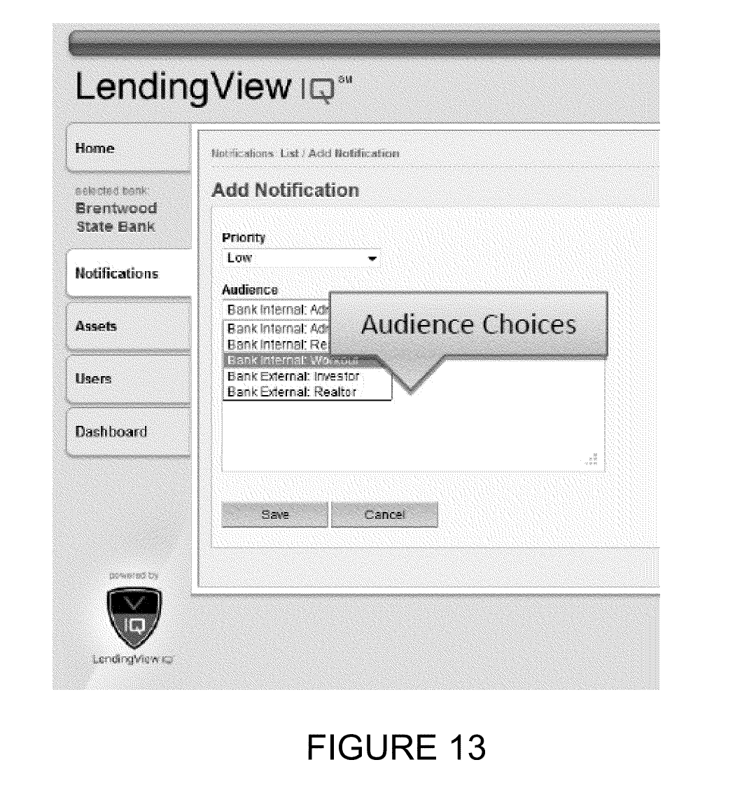

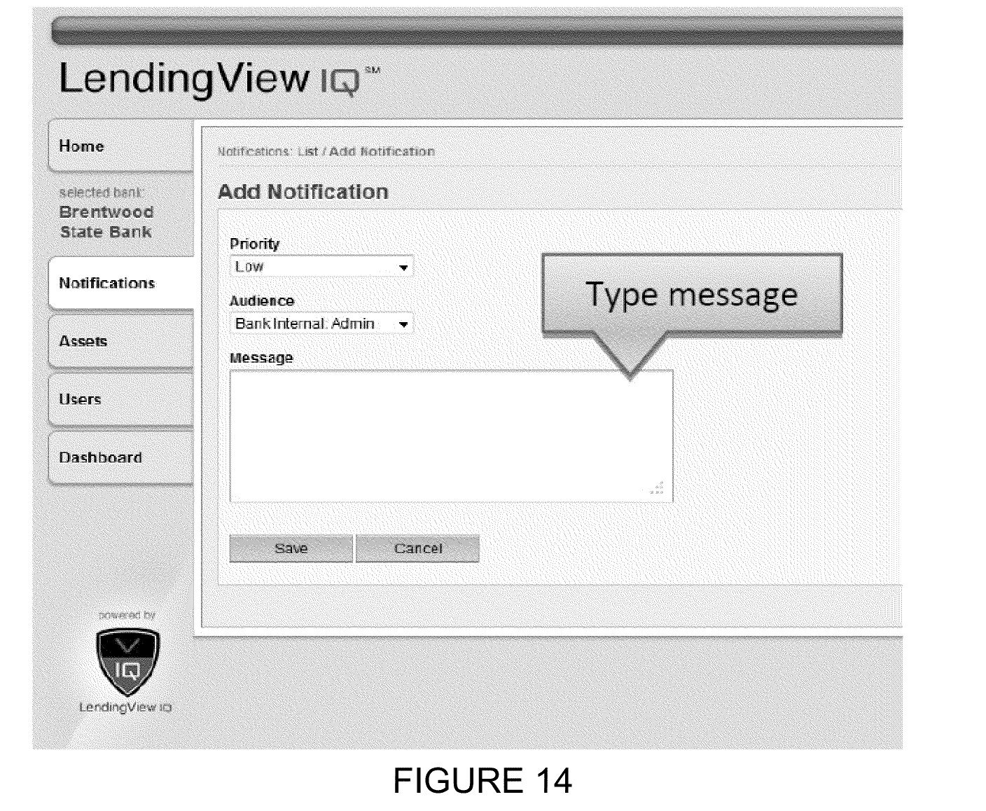

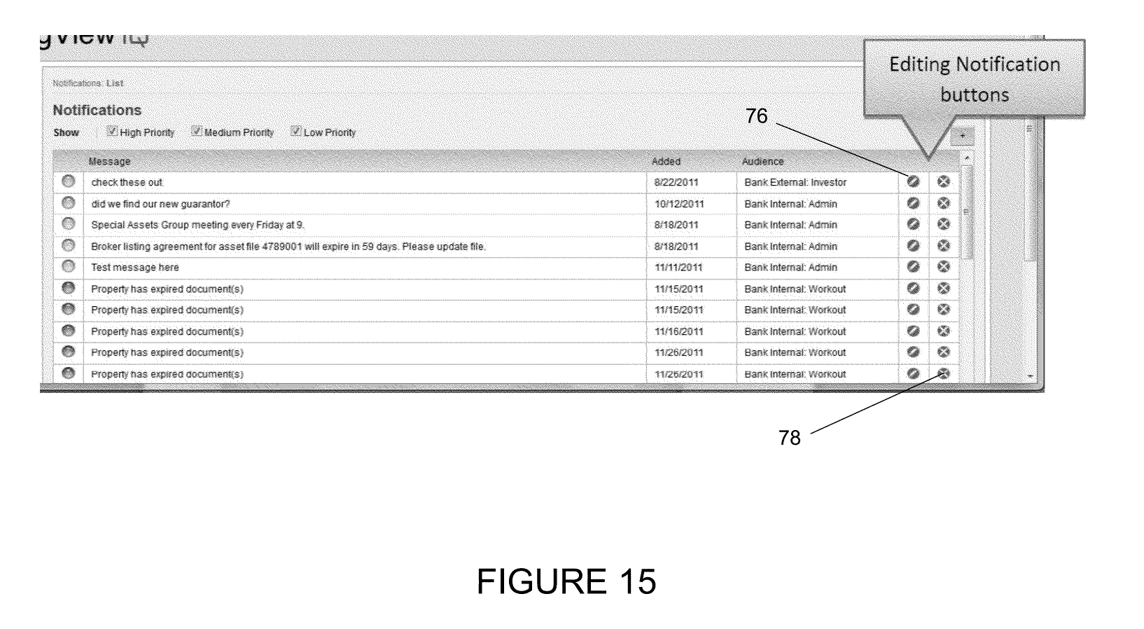

Internal administrative users can make several changes to Notifications. The user can generate a new notification (in the embodiment shown, by clicking on the “+” 72 on the screen), and then selecting the priority (e.g., high, medium, and low). The user then selects the audience (as seen in FIG. 13), types the message (as seen in FIG. 14) and saves the message to generate the notification. The user also can edit and delete notifications. In the embodiment shown on FIG. 15, two buttons are shown in the rightmost columns, one for editing 76 and one for deleting 78.

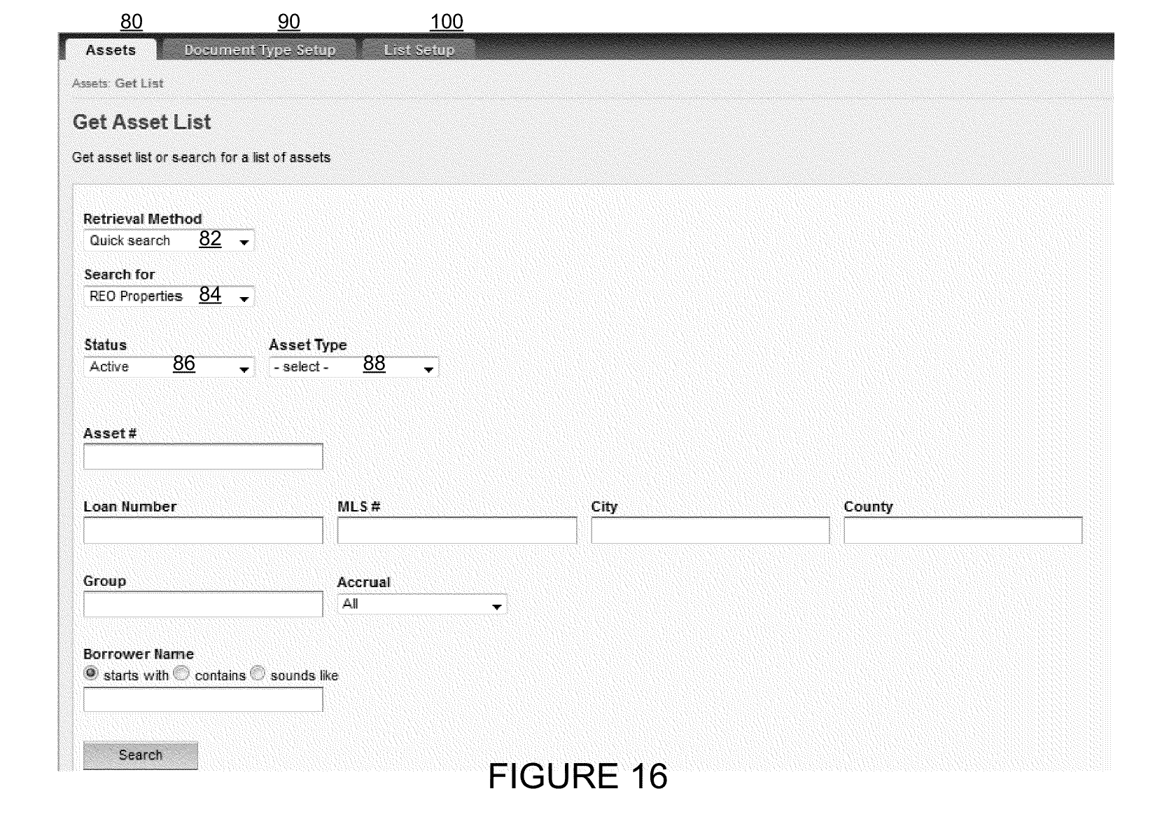

The Assets tab displays information related to each asset or property. As seen in FIG. 16, the Assets tab is divided into three sections accessible by tabs across the top of the window. The Assets sub-tab 80 presents a search screen that allows the user to search for assets or properties. In the embodiment shown, the user can select the retrieval method 82 (e.g., quick search, advanced search, get all active, and get all archived) and type of asset to “search for” 84 (e.g., REO Properties, All Notes, Performing, Non Performing) using drop-down menus. The user can limit the search by status 86 (e.g., active, archived, active or archived) and asset type 88 (e.g., development, land, multi-family, residential). Searches can also be performed by asset number, loan numbers, MLS listing, city, county, group, borrower name, or other miscellaneous criteria. Advanced searches, for example, can be performed based on minimum appraisal, maximum appraisal, loan type, state, country, region, postal code, or property type.

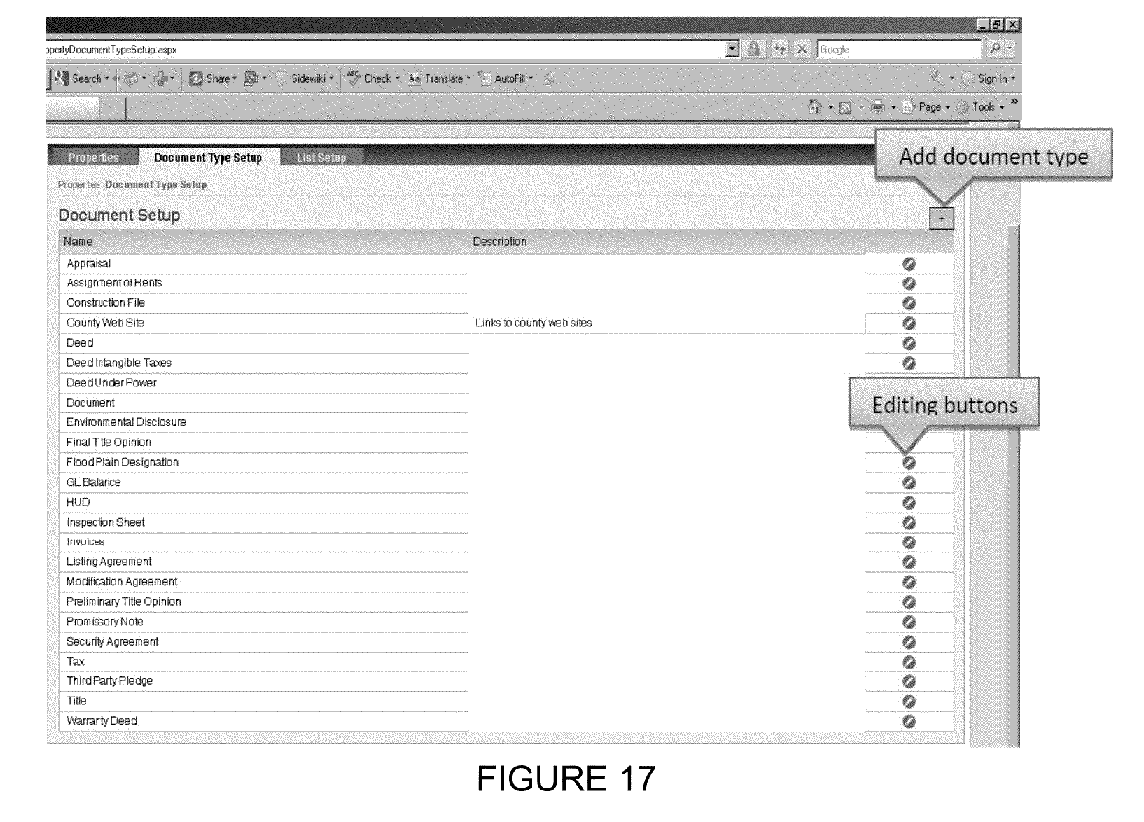

FIG. 17 shows an example of the document type set up sub-tab 90. This is where the user adds documents types for all files. The system provides a list of document types, and additional types can be added. Editing and modification tools are similar to those described above.

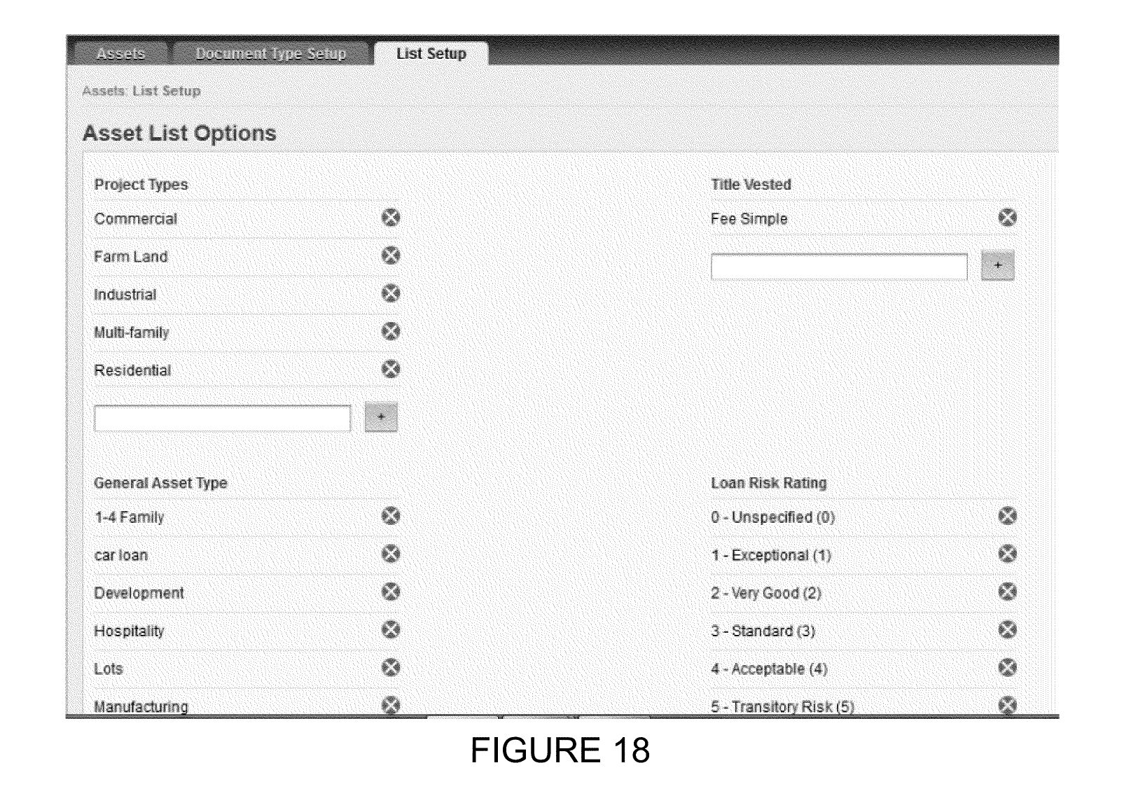

FIG. 18 shows an example of the list setup sub-tab 100. This presents property list options that allow the user to categorize properties by multiple criteria types. Editing and modification tools are similar to those described above.

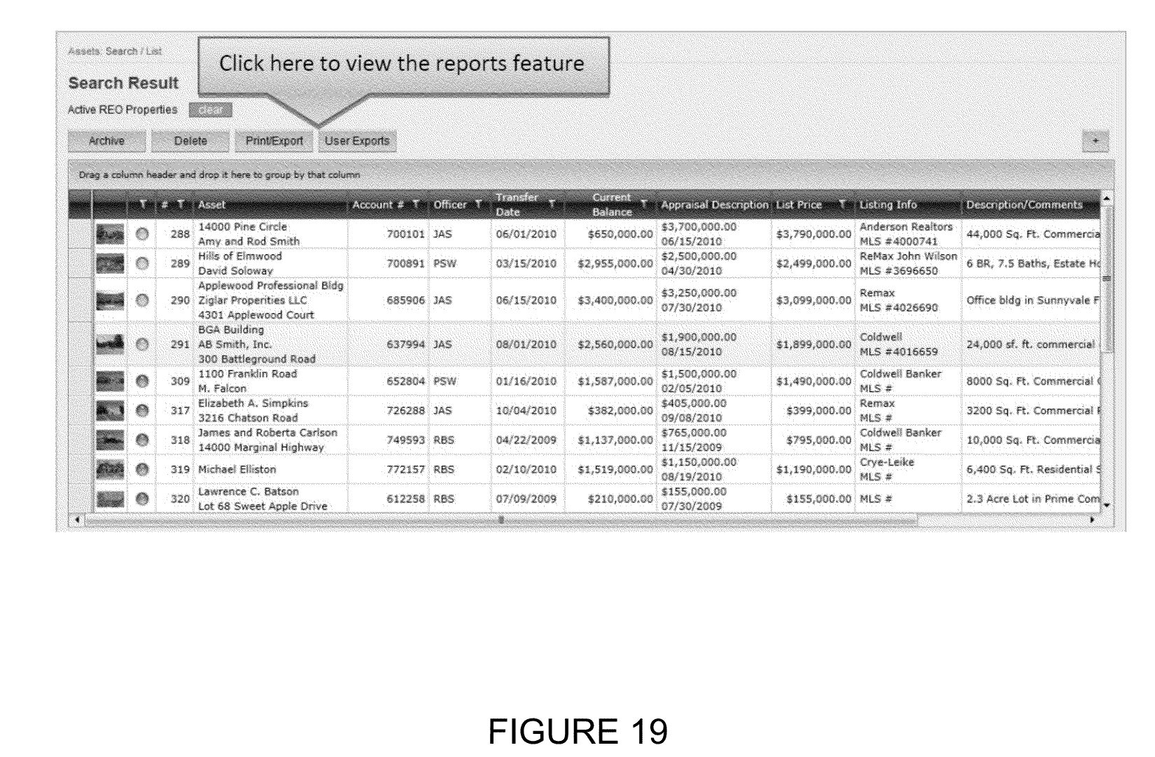

FIG. 19 shows an example of the results of a search. The list presented may contain alerts to advise the user of expired or missing documents and information. In the embodiment show, a red circle is used to indicate that the asset has not been marked as completed or is missing an applicable document, a yellow circle indicates that the asset has at least one applicable document that is expired, and a green circle indicates that the asset has been marked as complete and all applicable documents are present and updated. The user also can print or export the list or the information in the form of a variety of reports, which can be pre-determined or customized.

Examples of reports include, but are not limited to appraisal expirations reports (Loan Number, Borrower Name, Location, Description, Current Balance, Appraisal Value, Appraisal Ordered Date, Document Expiration Date, Last Appraisal Date) for expiring appraisals (e.g., active appraisal documents within 120 days of expiration date) and expired appraisals; OREO projected sales (Description, Current Balance, Appraisal Value, Projected Sales Price, Projected Closing Expense (Write Up/Write Down), Projected Gain/Loss, SalesConfidence, % G/L, Projected Closing Date, Contract/Letter Of Intent); and OREO sales (Description, Current Balance, Appraisal Value, Sales Price, Actual Closing Expense, Gain/Loss $, Gain/Loss %, Actual Date Closed).

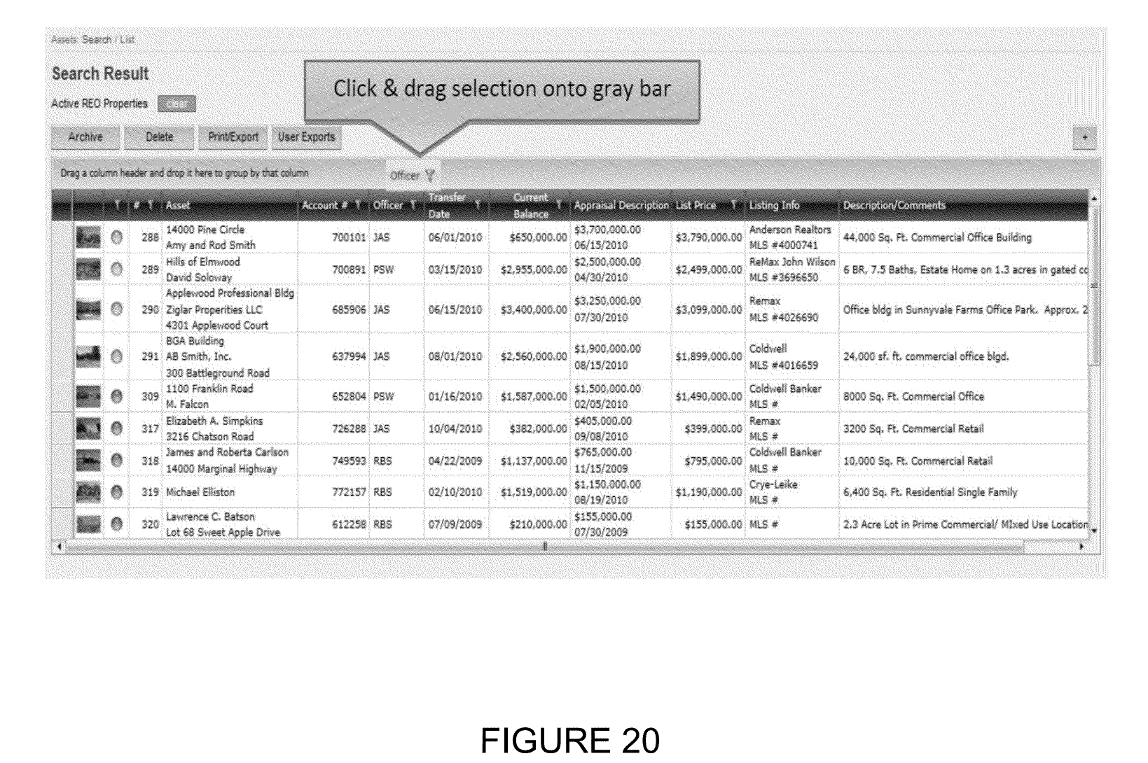

The search results can be sorted in a variety of ways. In one embodiment, the user can sort the results by clicking on the header for the column. Alternatively, in the embodiment shown in FIG. 20, the user clicks and drags the header for sorting onto a gray bar above the headers.

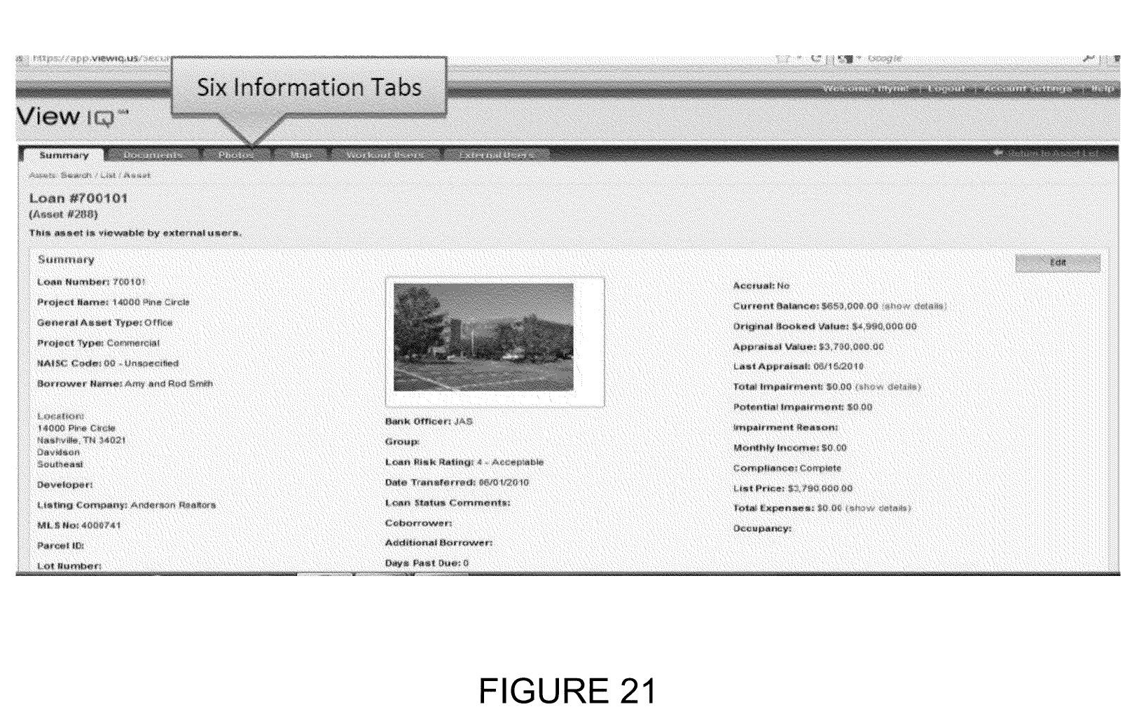

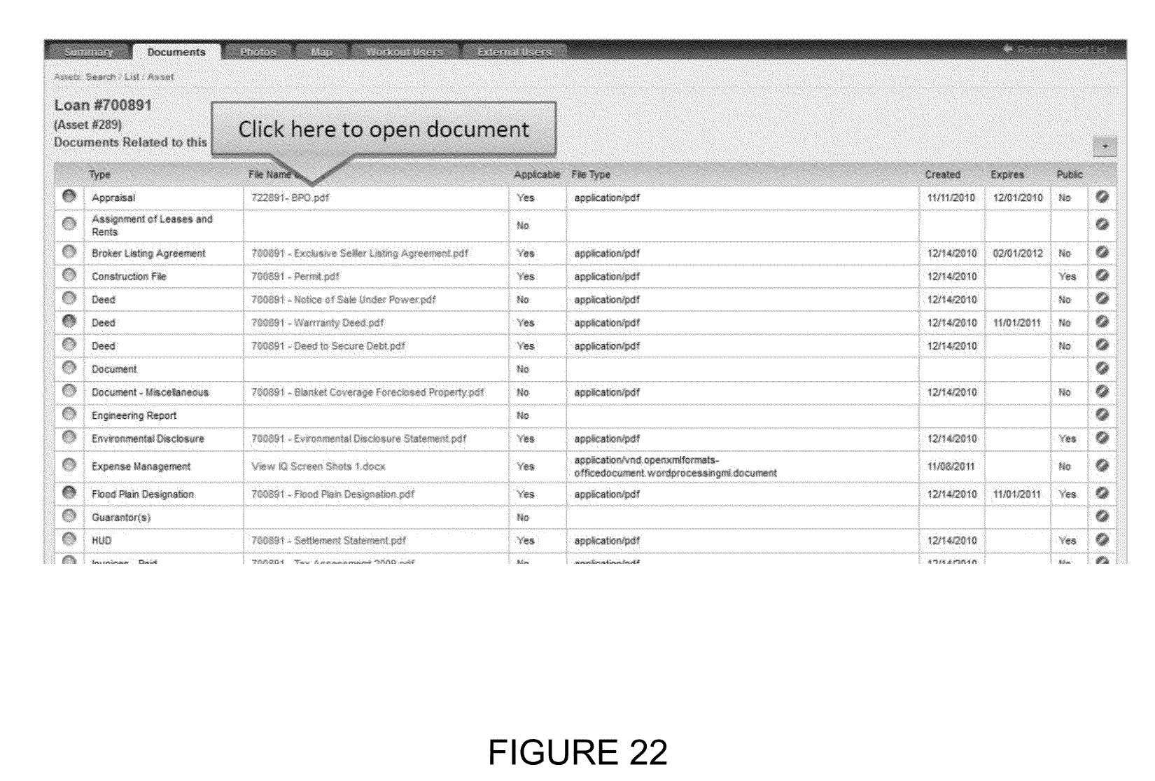

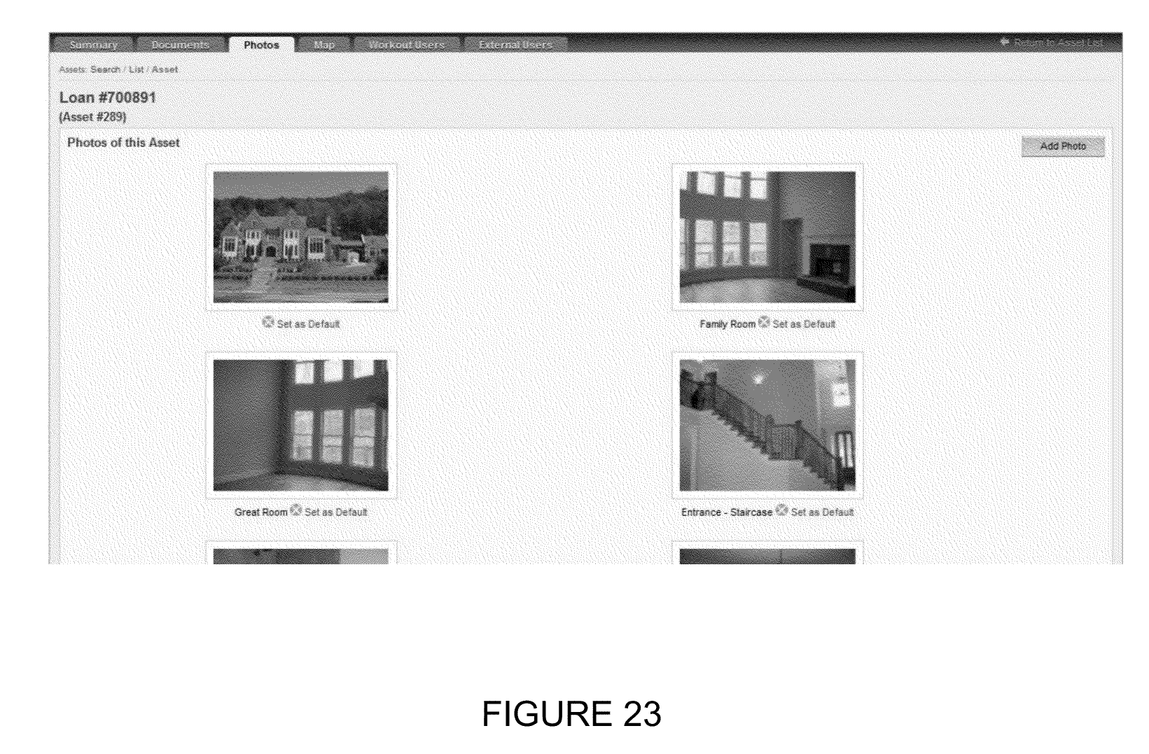

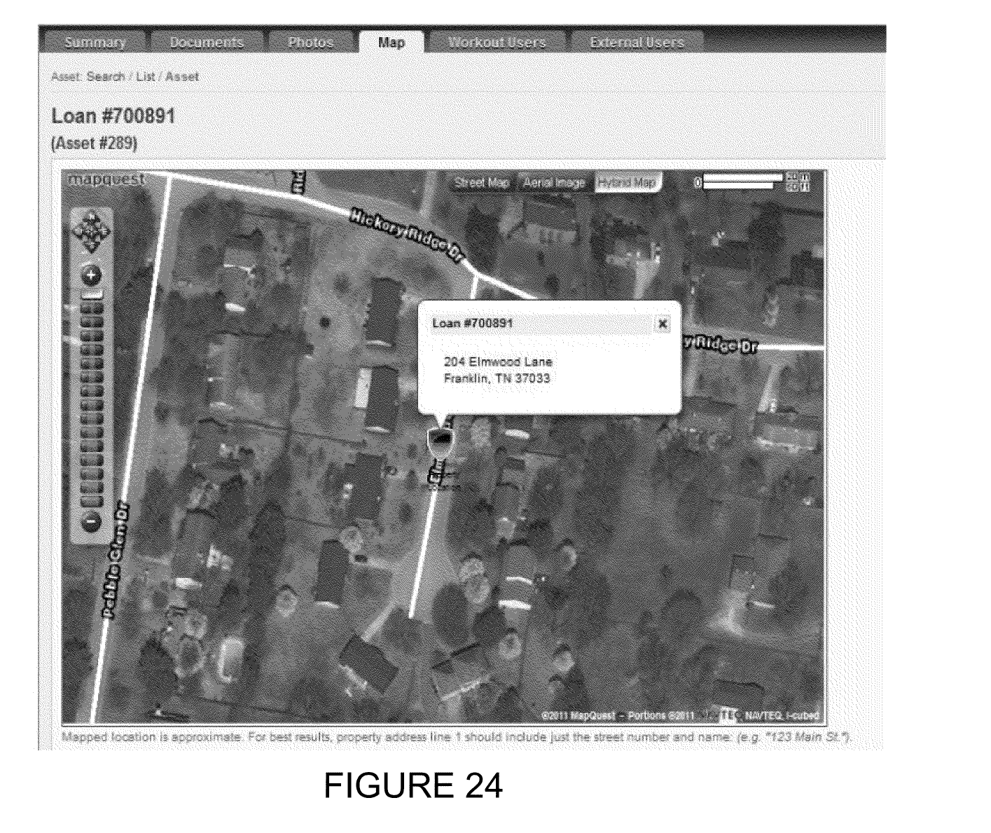

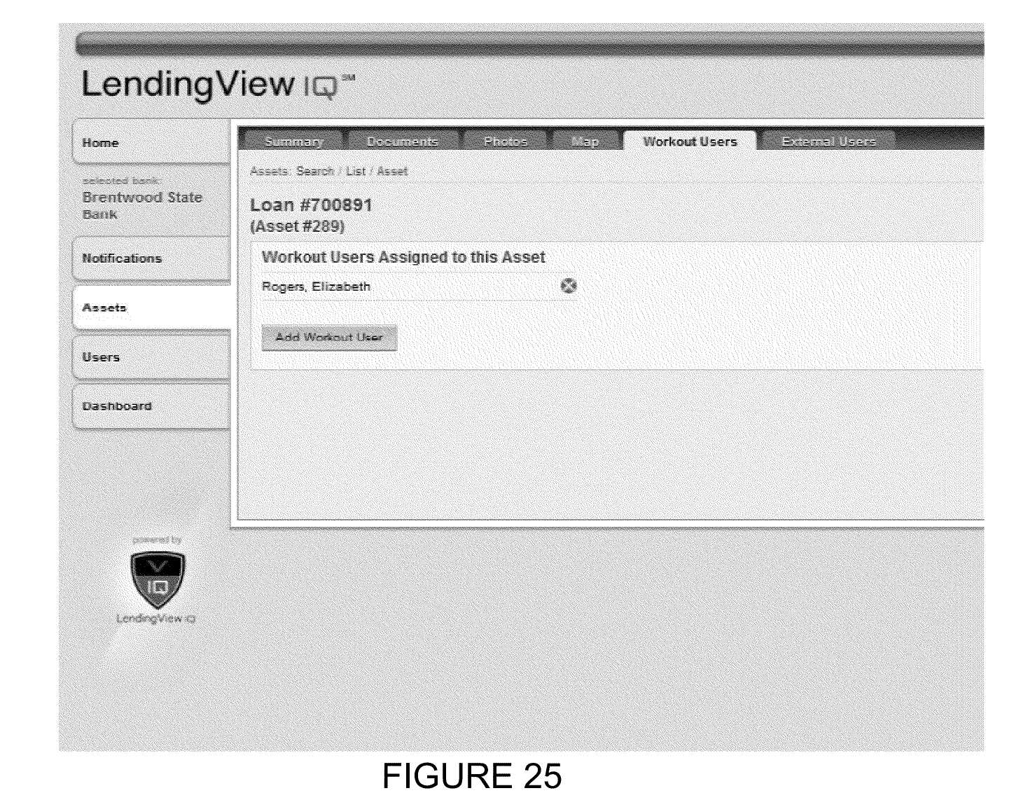

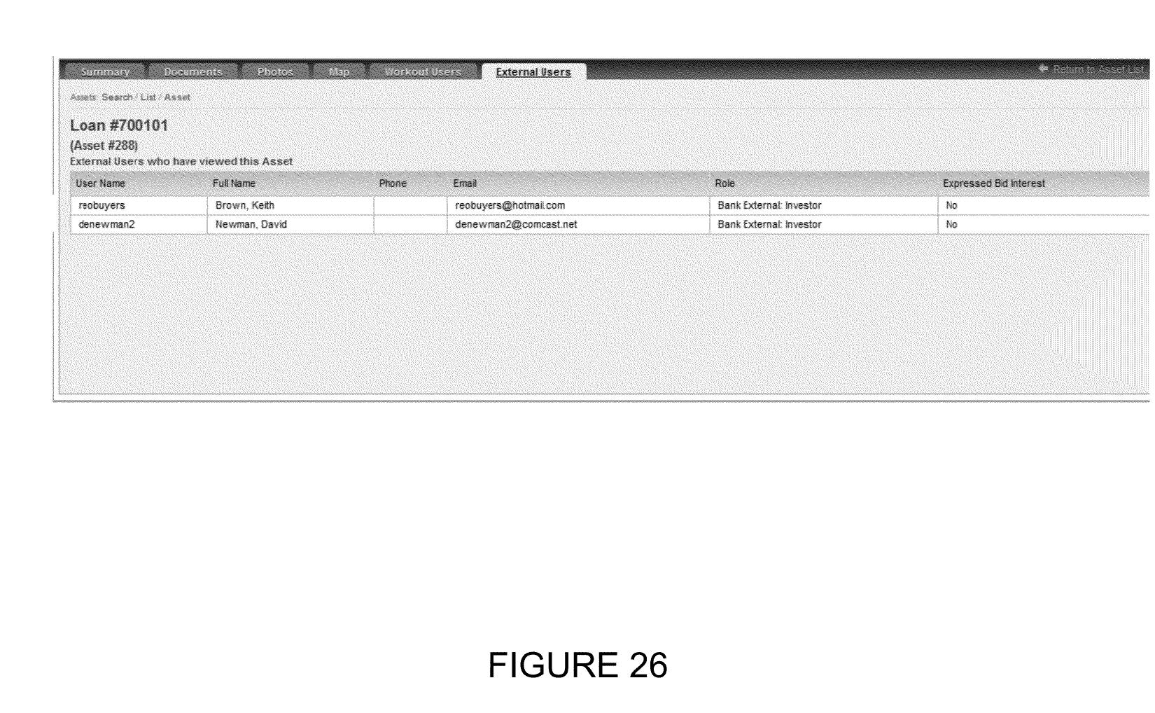

The user can select an asset or property to view in detail by clicking on the asset or property. This presents the user with an individual asset page, with six sub-tabs. FIG. 21 shows the individual property or asset summary view, which contains all of the basic information about the asset or property (e.g., location, type, loan number, and the like). FIG. 22 shows the documents sub-tab view, which permits the user to open and view and print on all of the documents available. FIGS. 23 and 24 show the photos sub-tab view (which includes multiple interior and exterior photos of the property or asset) and the overhead map sub-tab view, respectively. The user can view the users (e.g., workout users) who are assigned to this particular asset or property with the workout users sub-tab view, as seen in FIG. 25. The user also can see all external or third-party users who have looked at or viewed this particular asset or property, as seen in FIG. 26.

As noted above, the Assets tab permits an authorized user to create new property or asset files and upload related documents. An asset or property is an unique entity that is usually associated with a loan or loan identification. Each asset or property can have a plurality of values assigned to it that provides additional information about the asset or property.

An uploaded document typically is an electronic file associated with the property. Documents include, but are not limited to, such items as a tax receipt, a note, an appraisal, or other loan-related documents. Each documents is assigned a document type, visibility settings, and applicability settings. Documents may be stored in any suitable format, including PDF, HTML, Word documents, or similar formats. Documents also may be linked to any Internet URL (web address). Thus, for example, a document could be linked to a web address that contains the property tax records (e.g., public county web site with the tax records).

Photos are computer image files in any suitable format, including PDF, jpg and gif. An unlimited number of photos may be attached to each asset or property file.

The first step in the document uploading process is the identification of all relevant bank documents associated with the property or asset file. A new property file refers to a property that is being uploaded for the first time to the system. An existing property file refers to a property file that currently resides on the system and is being updated with a new document or documents.

Some client institutions use document imaging systems that electronically scan some or all relevant documents. Some institutions rely on a combination of scanned images and hard copy documents. Other institutions rely on hard copies alone. All documents to be transferred to the system must be in an imaged format, as noted above.

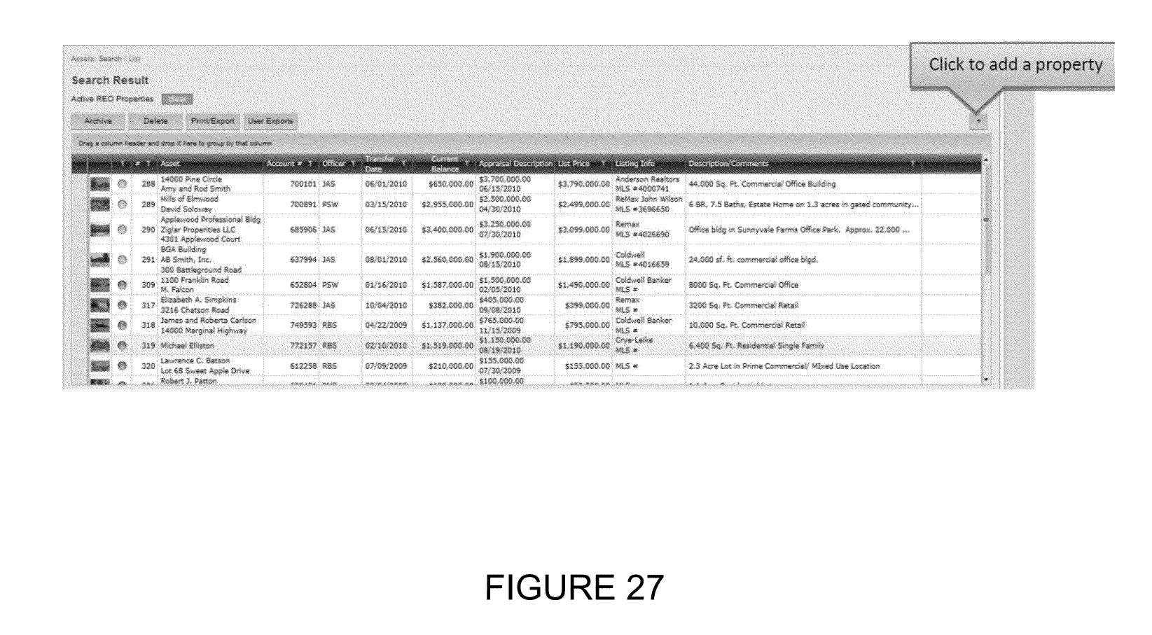

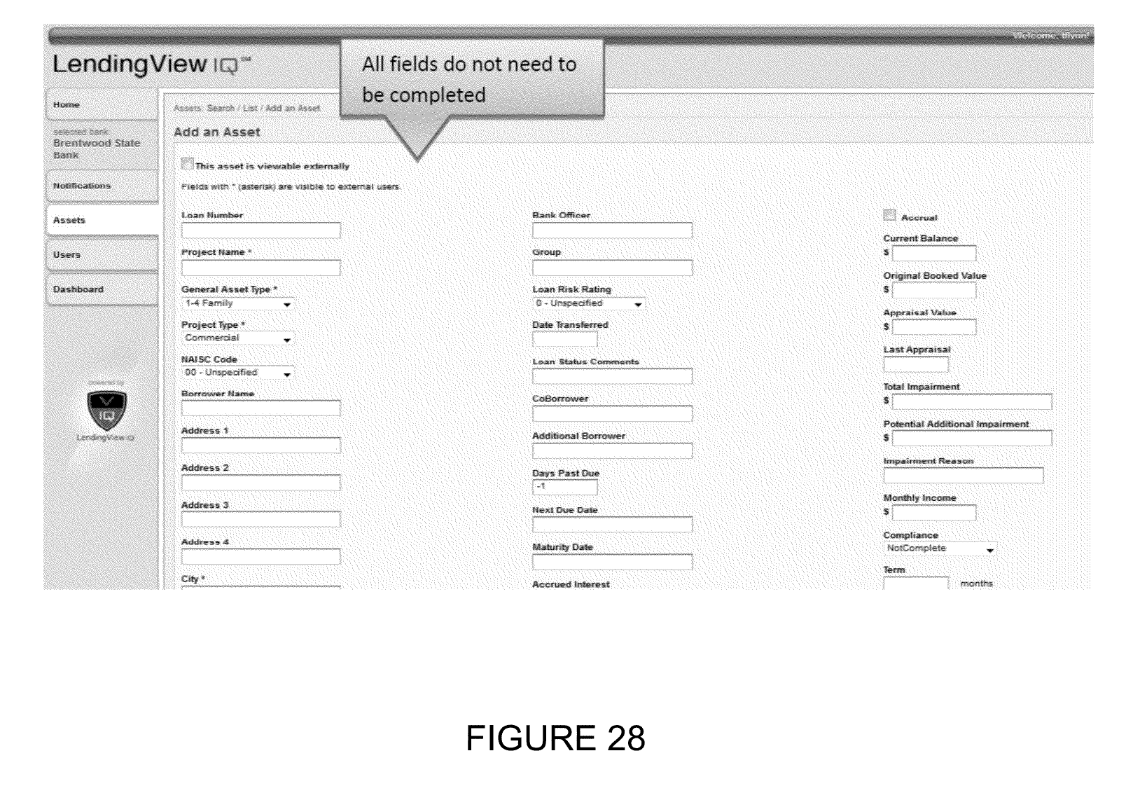

In one exemplary embodiment, an authorized administrative user can implement the add asset function by clicking on the “+” on the Asset tab screen, as seen in FIG. 27. The add asset screen is shown in FIG. 28. The user enters the relevant information to identify the property (although not all fields need be completed), and saves the file when done. Data includes the data fields shown in FIG. 28. Additional data fields include Appraisal Ordered Date (date most recent appraisal was ordered); Selling Price (price property is expected to sell for); Projected Closing Date (date of projected closing of sale); Buyer Commitment Type (Contract or Letter of Intent); Sales Confidence (High/Low); Sales Price (actual price sold for); Closing Date (actual date of sale); Closing Expenses Projected (projected closing expenses itemized); Closing Expenses Actual (actual closing expenses itemized).

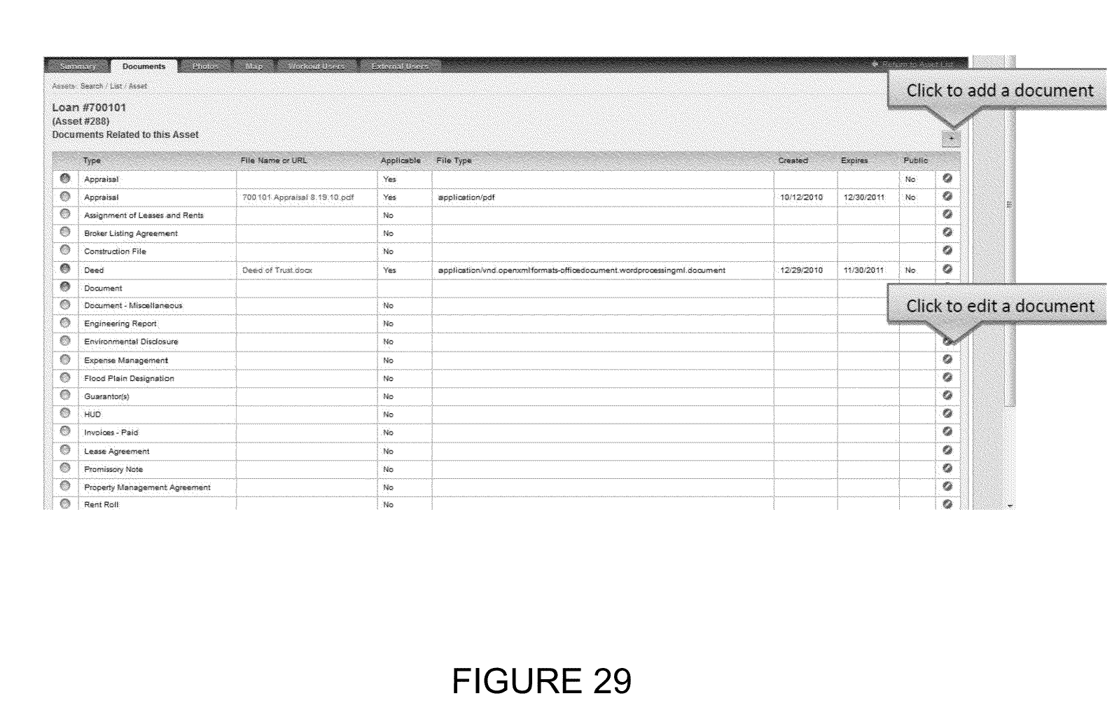

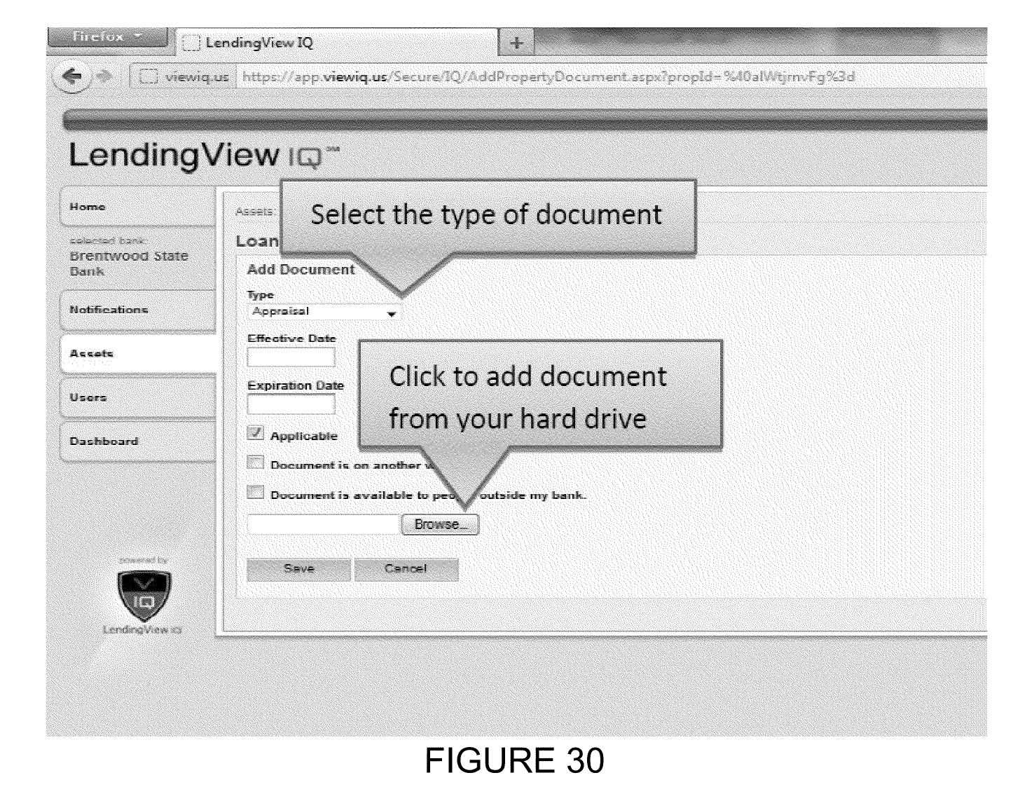

The user can then upload documents associated with that property or asset. This process is also followed for uploading documents to an existing property or asset. The documents to be added should be stored on an accessible computer drive (such as a local drive or network drive). The user chooses the property or asset in the list to open the property summary screen, chooses the Documents sub-tab, and is presented with a list of standard documents types (as discussed above), as shown in FIGS. 29 and 30. The user then clicks on the document type to be added, enters relevant data, enters the location of the electronic form of the document (or browses to find the document), and uploads it to the system. If the document is to be counted towards a “complete file,” the user checks the box labeled “applicable.” If the document is on another web site, the user checks the box labeled “document is on another website.” If the document is to be visible to external users, the user checks the box label “document is available to people outside my bank.”

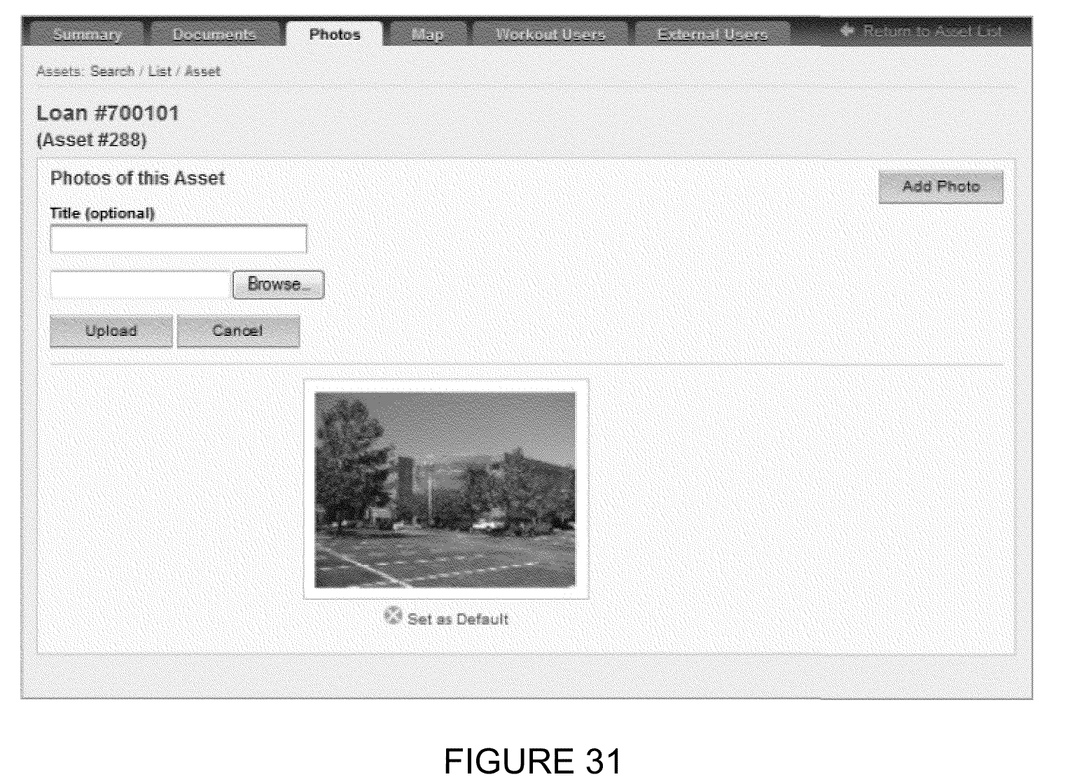

A similar procedure is used to upload photos related to a property or asset, as seen in FIG. 31.

Expenses for a property also can be tracked and edited. The user locates the desired property or asset using the search function discussed above, choose the property on the list to open the property summary screen, clicks on the edit button, locates the total expenses field, and clicks on “adjust” to open the field. The user uses the drop-down menu to select whether to “write up” or “write down”, and then enters the amount of the adjustment and any comments necessary. The user also may select a category. The user then clicks add to store the information, confirms that it is correct, and saves its.

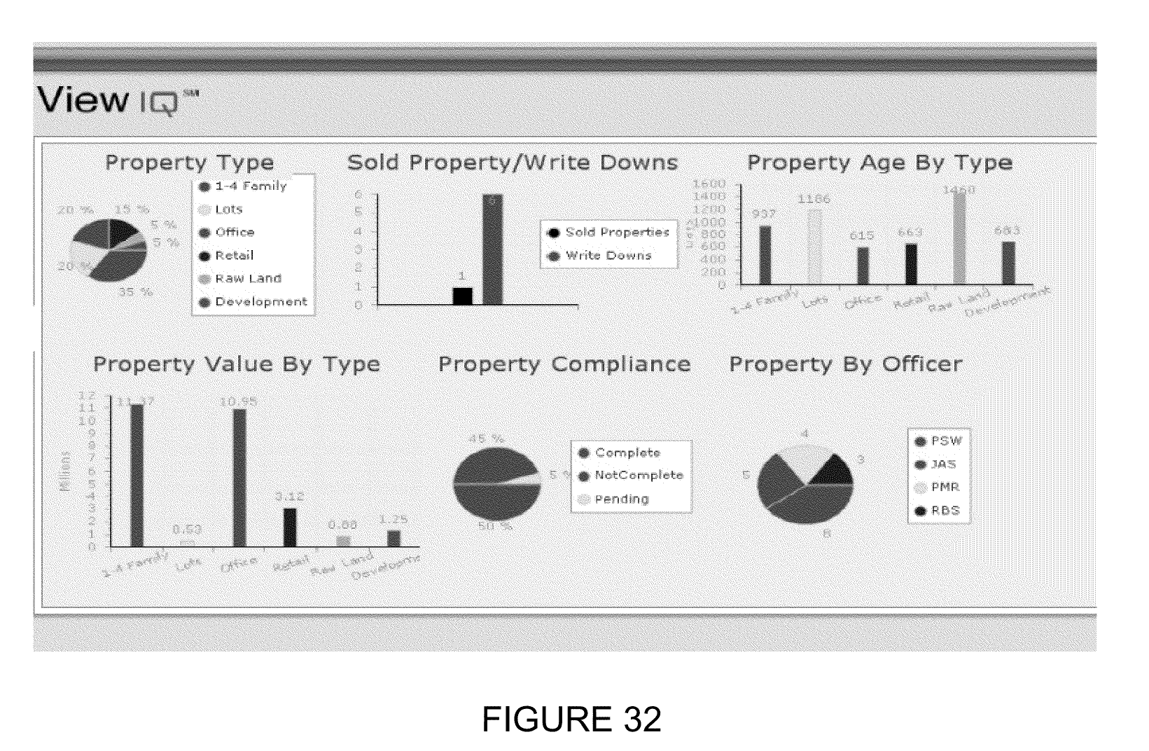

The Dashboard tab provides an overview of the entire portfolio, which varies depending on the user, as shown in FIG. 32. This display shows a variety of summary information, which may be in the form of pie charts, line or bar graphs, tables, or otherwise. Summary information includes, but is not limited to, breakdowns by property type, sold properties/write downs, property age by type, property value by type, property compliance, and property by officer, among others.

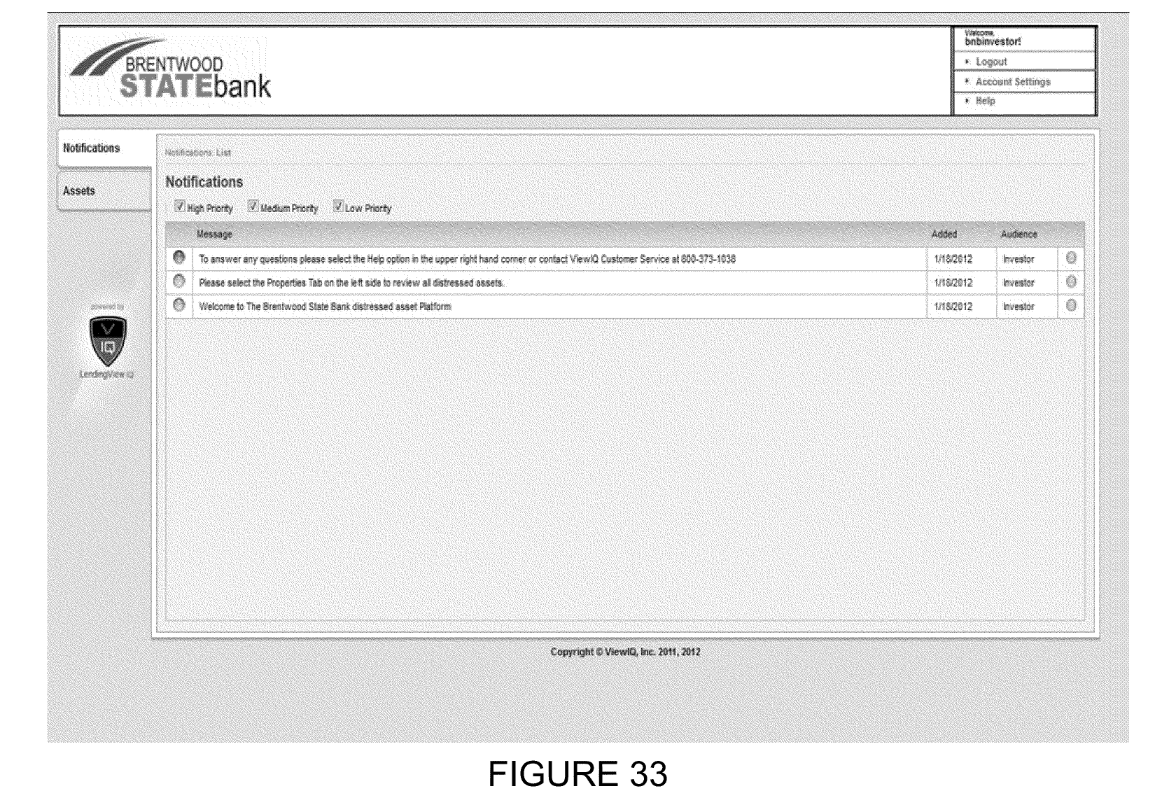

A third-party user is generally limited to the Notifications and Asset tabs, and the amount and type of information presented here is more limited than an administrative or internal client user. An example of a third-party Notification screen, for example, is shown in FIG. 33.

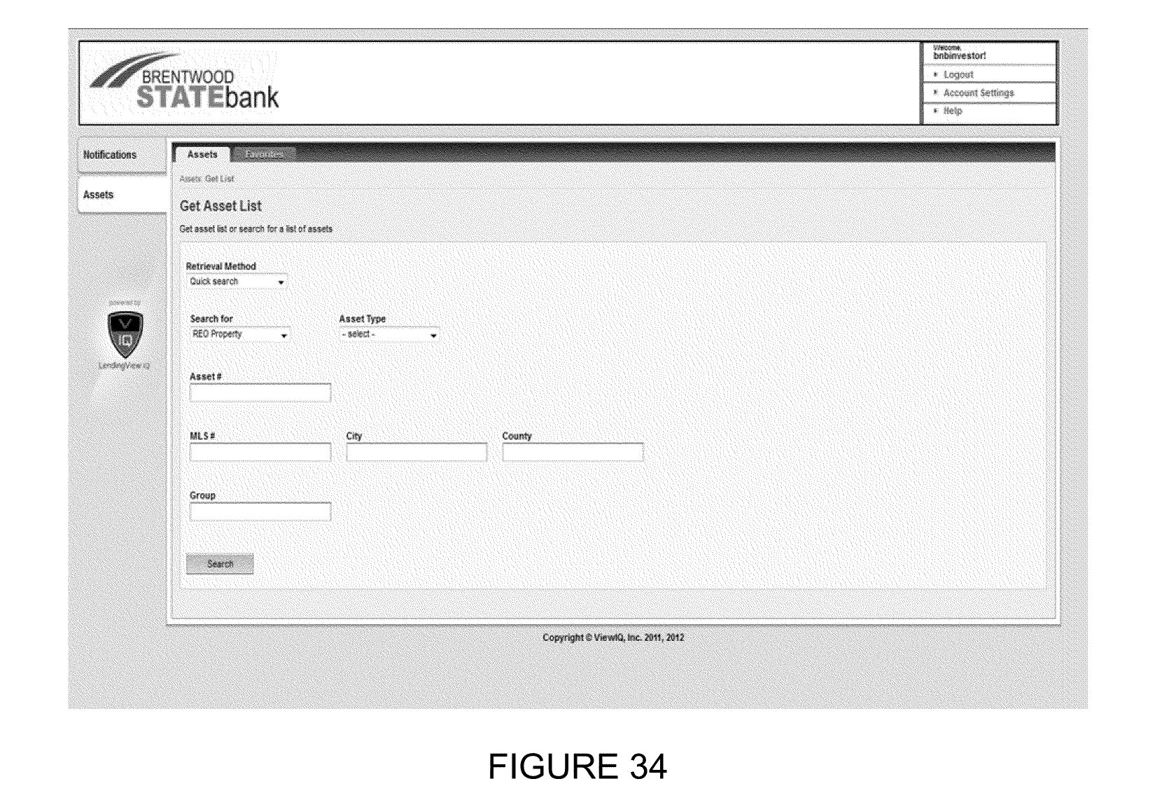

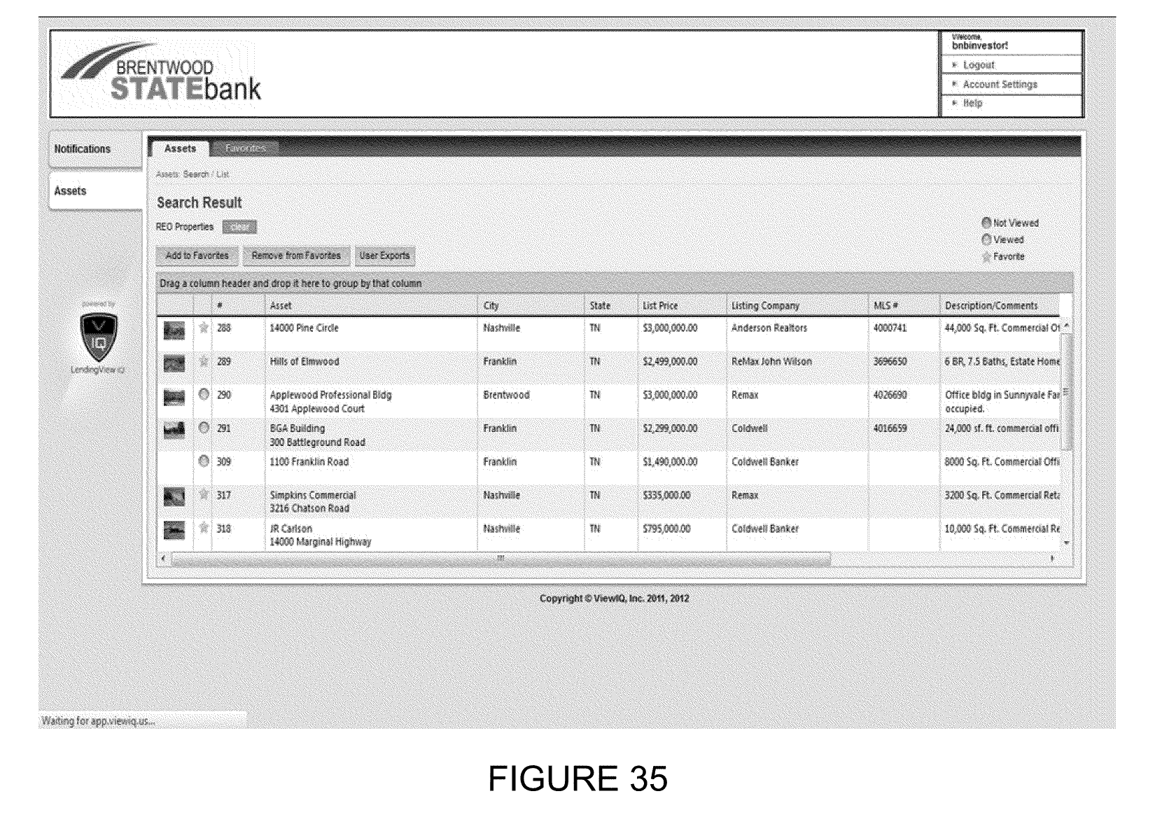

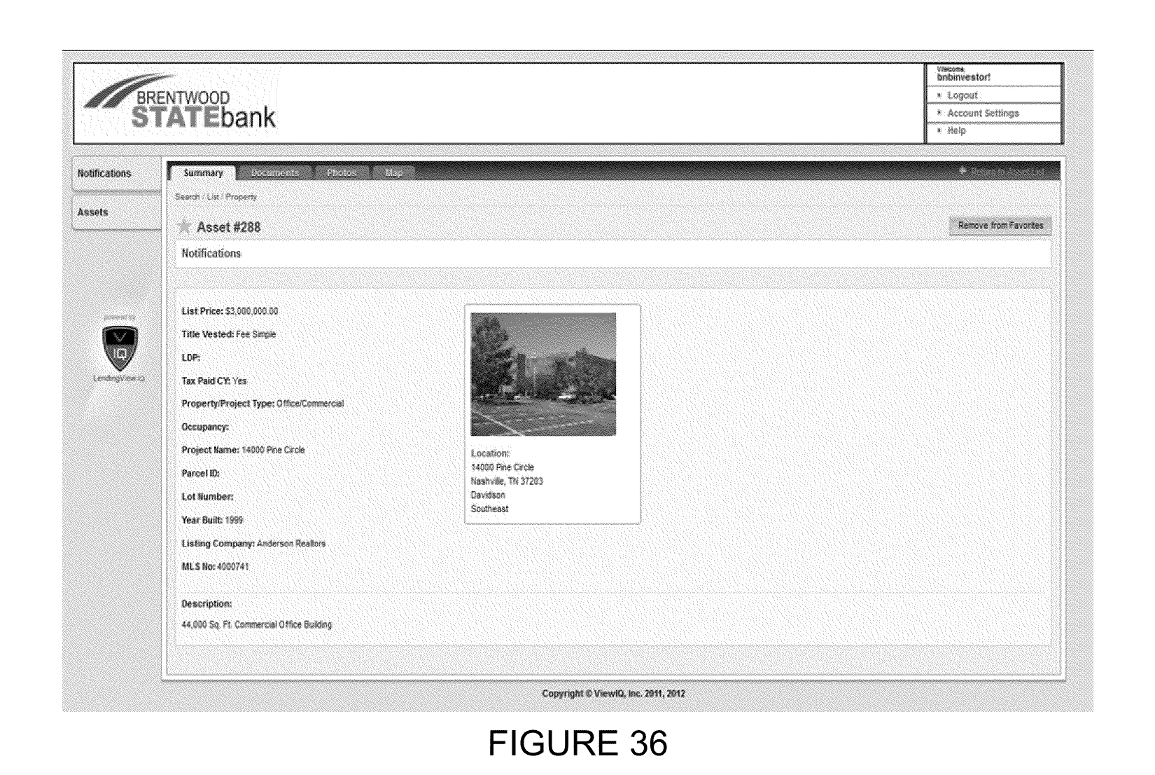

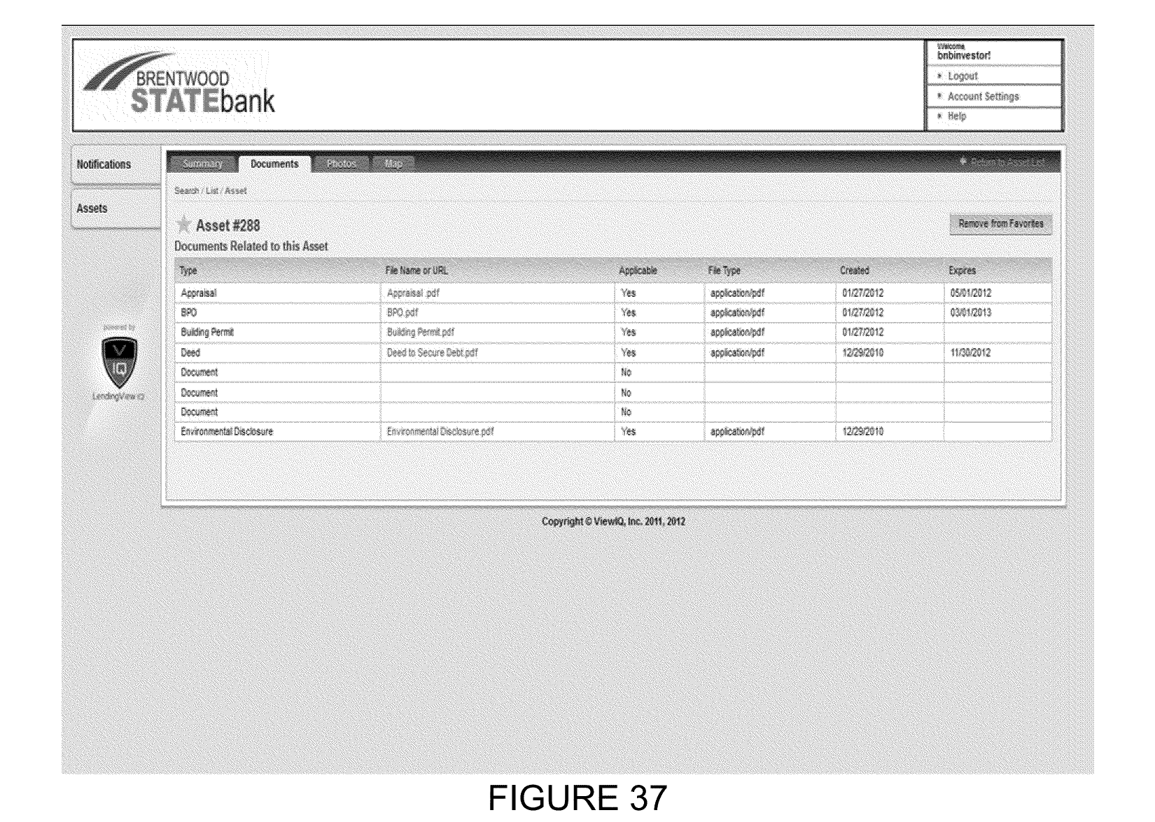

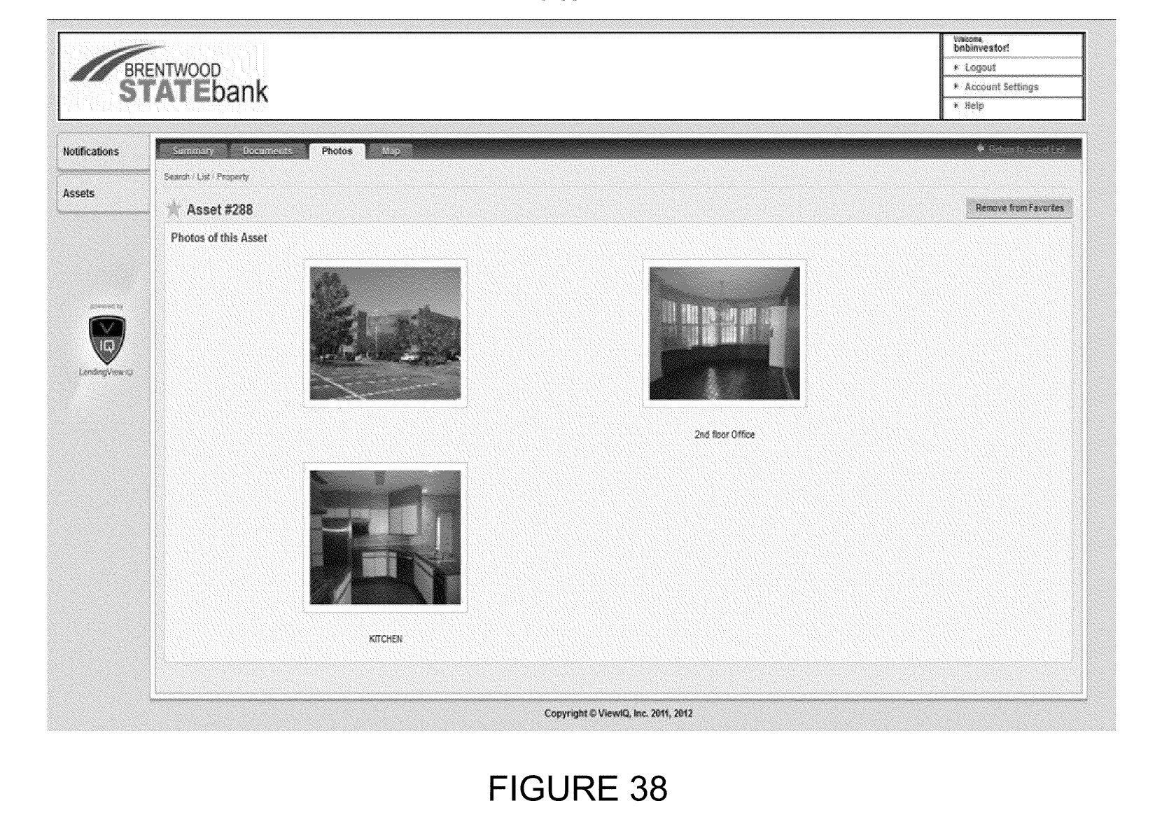

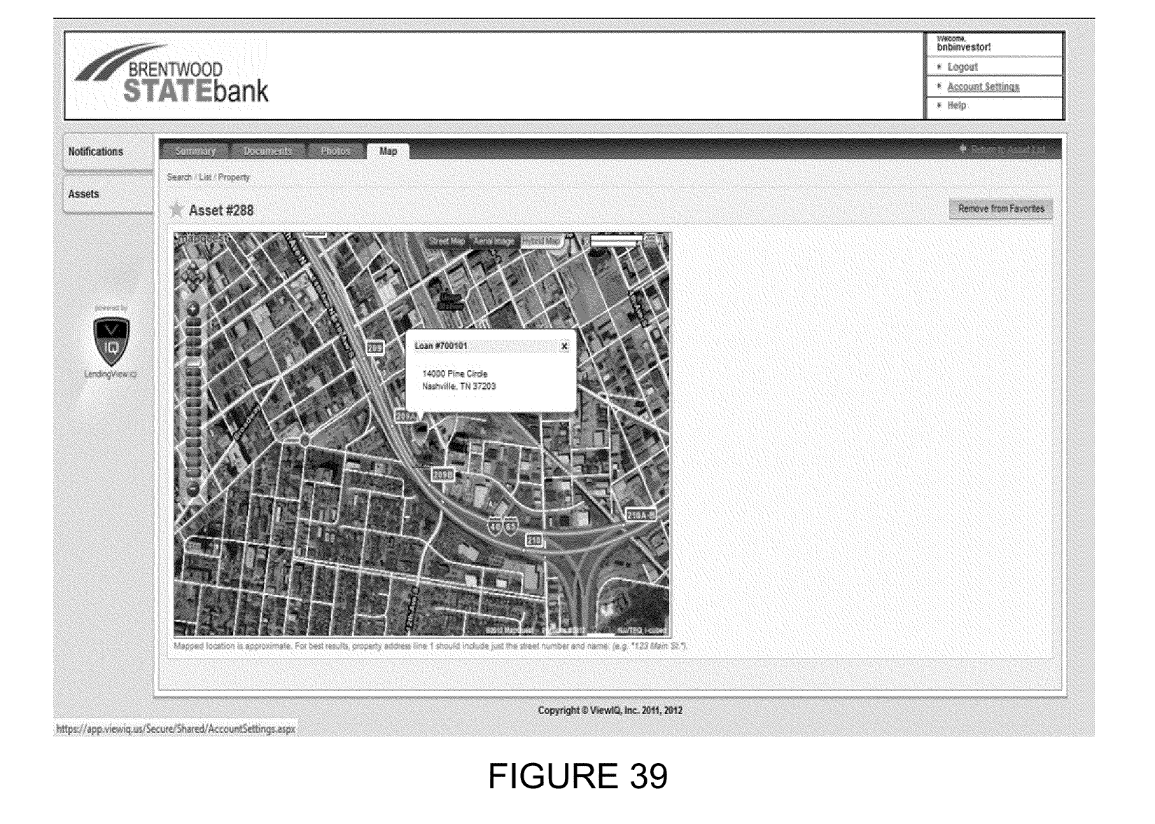

Third-party users generally use the Asset tab of the system to search and find properties and assets of interest. An example of a third-party “Get Asset” search screen is shown in FIG. 34. This functions in a similar manner to the search screen discussed above, and results in a similar search result list, as seen in FIG. 35. The user can then choose particular properties to review in more detail through the summary, documents, photos and map screens (similar to those discussed above), as seen in FIGS. 36-39.

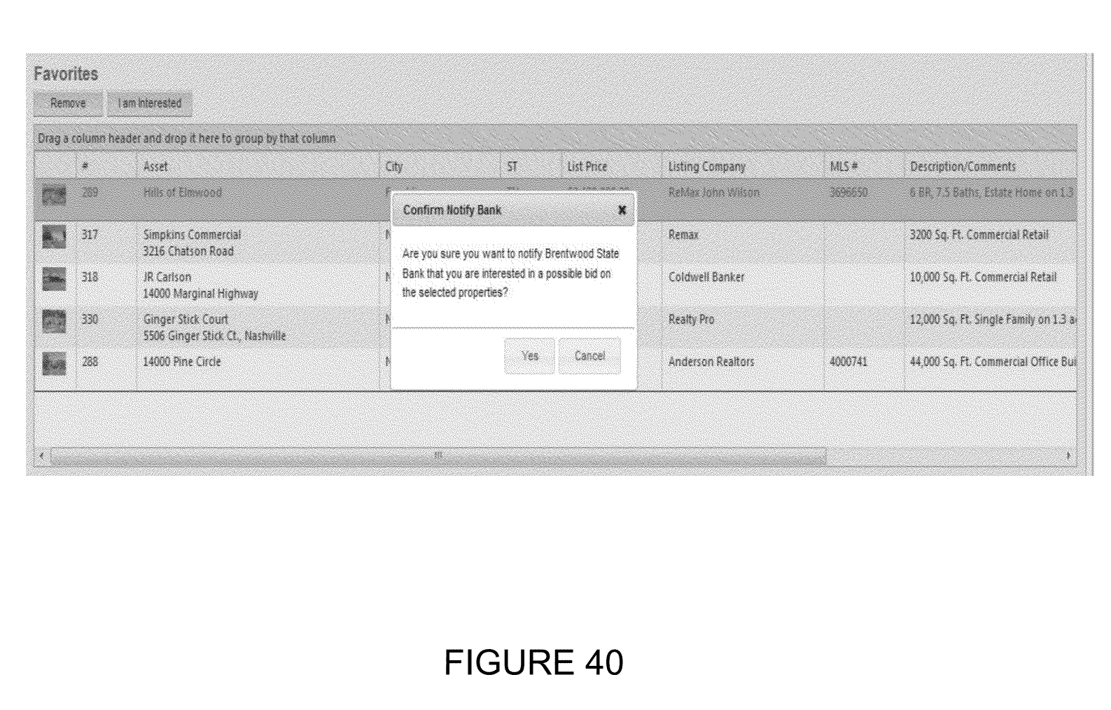

The third-party user or investor can flag properties or assets of interest so that they may be quickly accessed later. He or she also can notify an internal client user (such as a banker), that he or she has an interest in a particular property or would like to place a bid on it, by clicking an “I am interested” button or icon, or by otherwise indicating this desire. In one embodiment, the user is prompted to confirm that they want to notify the client institution of their interest, as seen in FIG. 40. The system then send a notice, which may be by email, to the internal client user associated with the property. The third-party user may include a comment or some text with the notice. The client institution also may designate other third-party contacts (e.g., brokers, attorneys, etc.) to receive these notices (as well as other notifications).

Third-party users may register generally with the system. Alternatively, they may register for a specific institution (e.g., bank) through a web page that include the institution's external registration key (to identify the institution).

Data security is an essential piece of the system's architecture. An audit trail documents all significant system events and the user who performed them.

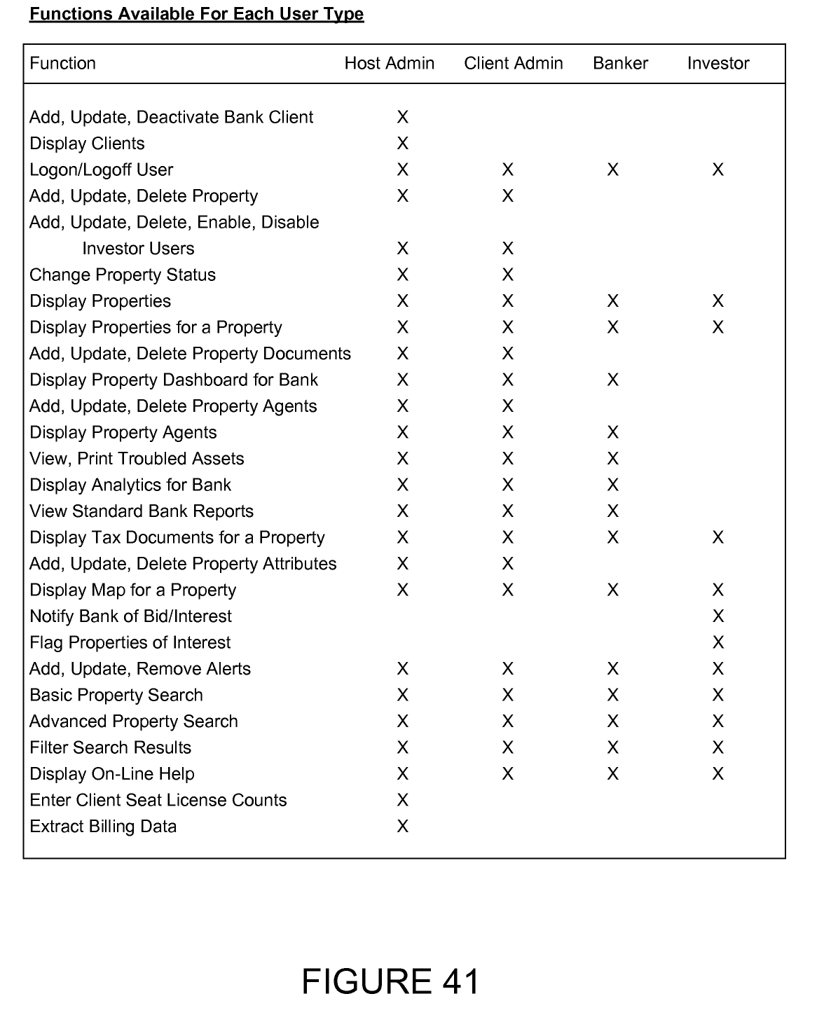

A summary table of functions generally to each user type for one exemplary embodiment is shown in FIG. 41.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for managing assets or properties, comprising:
a processor or microprocessor coupled to a memory, wherein the processor or microprocessor is programmed to manage assets or properties by:
receiving and storing data in a database about one or more assets or properties from an institution or entity holding, owning or controlling said assets or properties;
receiving a search request from a user not at the institution or entity;
conducting a search on the data in the database based on parameters in the search request; and
presenting the results of the search to the user;
wherein the asset or property data comprises information identifying the asset or property, one or more documents relating or associated with the asset or property, one or more photos of the asset or property, and a map showing the location of the asset or property.

2. The system of claim 1, wherein the assets or properties comprise real estate loans or mortgages.

3. The system of claim 1, wherein the user is an potential purchaser or investor.

4. The system of claim 1, wherein the user is a broker.

5. The system of claim 1, wherein the system receives input from the user designating assets or properties of interest to the user.

6. The system of claim 1, wherein the system receives input from the user requesting that user's interest in an asset or property be forwarded by the system to an internal institution or entity user.

7. The system of claim 1, wherein the processor or microprocessor is further programmed to carry out the steps of:
receiving and storing notification data; and
displaying the notification data to appropriate users.

8. The system of claim 1, wherein the system maintains a record of all users who look at a particular asset or property.

9. The system of claim 8, wherein an internal user at the institution or entity can view all users who have looked at the particular asset or property.

10. The system of claim 1, wherein the user can view the documents, photos and map associated with a particular asset or property.
